(19) United States
(12) Patent Application Publication
(10) Pub. No.: US 2011/0130216 A1
(43) Pub. Date: Jun. 2, 2011

(54) GOLF BALL CONSTRUCTS AND RELATED SYSTEMS

(75) Inventors: Jeremy Kim, San Diego, CA (US); Hyun J. Kim, Carlsbad, CA (US)

(73) Assignee: Taylor Made Golf Company, Inc.

(21) Appl. No.: 12/957,034

(22) Filed: Nov. 30, 2010

Related U.S. Application Data
(60) Provisional application No. 61/283,309, filed on Dec. 1, 2009.

(51) Int. Cl. A63B 37/12; A63B 37/00; B29C 45/14; B29C 45/36

(52) U.S. Cl. 473/372; 473/371; 473/378; 264/279.1; 425/577

(57) ABSTRACT

Golf balls and systems for applying one or more polymer layers to a golf ball construct are disclosed. As but one example of disclosed systems, methods for injection molding a golf ball cover surrounding a core and having a maximum wall thickness of about 0.030 inch are disclosed. In but one example of such methods, a viscous polymer can be injected into a mold defining a cavity. A core portion or mantle portion of a golf ball can be substantially centered relative to the cavity. A plurality of spaced-apart radial film gates can be circumferentially positioned relative to the cavity. The viscous polymer can be conveyed into the cavity through the plurality of radial film gates and into a volume defined between the core portion or mantle portion and the mold so as to form a substantially uniformly distributed polymer layer. The polymer layer can solidify. A golf ball construct can be removed from the mold cavity. In some implementations, the golf ball construct comprises an outer cover of a golf ball.

### CROSS REFERENCE TO RELATED APPLICATION

This application claims the benefit of U.S. Provisional Patent Application No. 61/283,309, filed Dec. 1, 2009, which is hereby incorporated by reference.

### FIELD

This disclosure concerns golf balls, and more particularly, methods and apparatus for applying one or more polymers to a golf ball construct.

### BACKGROUND

Some golf balls comprise a core and an outer cover comprising a polymer layer. A polymer layer of a golf ball can be applied using an injection molding process. In such a process, a golf ball core is typically retained by core pins within a mold cavity, and polymer is injected into an open volume between walls of the cavity and the golf ball core, thereby forming the polymer layer. Although industry has devoted considerable resources to optimizing the manufacture of the polymer layers, particularly the outer cover, conventional processes result in quality defects and other limitations.

For example, conventional processes can shift the core within the cavity, resulting in an off-centered core and variable cover thickness in the finished ball. Off-centered cores, deviations in roundness, variations in cover density, and variations in cover wall thickness can negatively affect flight characteristics of the golf ball. In addition, variations in the supply of injection material among fluidly coupled cavities can increase the difficulty of providing multi-cavity molds capable of producing balls having substantially identical flight characteristics.

Typically, when a part is injection molded, gas is trapped at a distal end of the injection material's path. Trapped gasses can lead to a number of quality defects, including voids, material degradation, and readily apparent knit lines. Vents are typically located at a pole of a spherical cavity. With conventional molds the flow path terminus may not be located adjacent such a vent, resulting in inadequate venting of the mold and associated defects.

As used herein, “pole” means a region of a hemisphere furthest from a corresponding equator. For example, a recessed hemispherical mold cavity defines a pole in a region furthest from a parting line of the mold. A golf ball defines opposed poles in opposed regions furthest from and separated by a selected major circumference encircling the ball.

Knit lines typically form at intersecting flow fronts, and trapped gas at these intersections can inhibit intermingling of the flow fronts, resulting in weak intersections. A weak knit line in a golf ball can initiate a fracture when the ball is struck by a club. Conventional injection molds for golf ball covers have up to 24 separate gate locations and a correspondingly large number of knit lines. A large number of gates also increases the shear forces applied to the injection material (e.g., a polymer) as it flows in the cavity, which can evolve additional gas and exacerbate the formation of knit lines.

Processing variables affecting a quality of the finished part can be imposed by constraints outside of a manufacturer's control and not easily changed by the manufacturer. For example, material properties, such as phase-change (e.g., melting) temperature and viscosity, and mold characteristics such as gate size and location, and venting design can be difficult to change. In contrast, other process variables such as injection velocity, transfer position, and hold time can be readily controlled during manufacturing. Easily adjusted variables and the range of values corresponding to each that can produce an acceptable part is sometimes referred to as a “processing window.” A processing window providing a large number of controllable variables and/or broad ranges of controllable parameters can provide the manufacturer with sufficient control to produce satisfactory parts despite imposed constraints, such as, for example, room temperature, material viscosity, or aged and/or deteriorating machine parts. In conventional injection molding processes of the type capable of producing golf balls, the processing window is small, and manufacturers have difficulty overcoming quality defects and/or producing a thin layer of injected material. Such small processing windows also prevent cycle time reductions and corresponding cost reductions.

Despite previous attempts at providing thin outer covers and other layers of golf balls, maintaining sufficient surface coverage, adequately sized dimples, and commercially acceptable defect rates using conventional injection molding techniques has been difficult or impossible to achieve.

### SUMMARY

Golf balls and systems for applying one or more polymer layers to a golf ball construct are disclosed.

Disclosed mold systems can comprise a single cavity or a plurality of cavities. A plurality of cavities can increase throughput. Some systems have an even number of cavities, and some provide symmetry among the cavities, thereby improving flow balance among them.

In some disclosed systems, radial film gates convey injection material into a mold cavity. A sub-runner system can be positioned adjacent the gates in an upstream position and can comprise a full-round primary runner. The primary runner can arcuately extend (e.g., partly circumferentially) around a portion of a cavity and can fluidly couple a sub-runner to one or more disclosed radial film gates. In some embodiments, such a sub-runner defines an inner radius and a corresponding inner surface. The sub-runner can define substantially flat upper and lower land surfaces.

One aspect of this disclosure concerns radial film gates in fluid communication with a mold cavity. In one embodiment, four radial film gates are circumferentially positioned relative to a corresponding cavity. Other embodiments can comprise a different number of gates (e.g., 2, 3, or more). Some embodiments comprise no more than about eight such radial film gates. In some embodiments, each of the plurality of gates occupies a substantially common plane. The common plane can lie parallel to a mold parting line.

For cavities that are substantially spherical, radial film gates can be equatorially positioned along at least about 45% of a major circumference up to about 90% of the circumference. Some gates can define an opening having a minor dimension of the opening (sometimes referred to herein as “thickness” or “gate thickness”) measuring between about 0.020 inch and about 0.060 inch. Some thicker gates can be better suited to molding a mantle layer of a golf ball and some thinner gates can be better suited to molding an outer layer (e.g., a cover) of a golf ball. A flow length of such a gate land (i.e., in a longitudinal flow direction relative to the gate) can range from about 0.020 inch to about 0.180 inch.

Another aspect of the disclosure relates to the shape of such gate openings (e.g., a cross-section of the gate at its intersection with a corresponding cavity). For example, some cross-sections comprise rectangular, stepped, tapered, or curved shapes, among many possible shapes. A gate opening shape can be based, at least in part, on a desired flow field of an injection material within the corresponding cavity and among separate cavities, (e.g., to balance flow fields within and among cavities). In some embodiments, one or more surfaces of a gate typically exposed to an injection material can taper so as to define a tapered opening thickness (or a tapering flow cross-section).

Spacing among gates corresponding to a cavity can vary. In some instances, gates can be arranged relative to at least one mold line of substantial symmetry so as to balance flow within the cavity, and/or among adjacent cavities.

Disclosed cavities can comprise two or more recessed portions. A first recessed portion can be defined by a first mold portion and a second recessed portion can be defined by a second mold portion. Each respective recessed portion can substantially define a recessed hemisphere. The first and second mold portion can be brought into a mating engagement so as to align the first and second recessed portions in an opposed relationship (e.g., the mold can be closed). When the mold is closed, the first and second recessed portions can define a substantially spherical cavity. A plurality of core pins can extend inwardly of such a cavity so as to retain a core placed within the cavity. The core pins can be retracted during a polymer injection process so as to fully expose the core to an injection material and thereby form a continuous spherical polymer layer enveloping the core.

Each cavity can also define a vent (e.g., located at a pole) for venting gas from the cavity during injection. A pin can extend through the vent and can comprise a porous material so as to facilitate venting.

Some disclosed systems can be used to mold a mantle or other internal layer of a golf ball. Some mantle layers comprise an elastomeric polymer.

Liquid polymer can be injected into the spherical cavity and allowed to solidify. Afterward, the core/polymer assembly part can be removed from the mold. The core pins can assist ejecting the part by hand, by a robot, and/or by gravity.

A variety of polymers can be used. In particular, polymers in the polyurethane and ionomer families, as well as blends incorporating polymers from said families, are well suited to golf ball related embodiments. As used herein, “ionomer” refers to ionomeric polymers, copolymers and blends that incorporate an ionomeric polymer component.

Methods of forming one or more golf ball constructs are disclosed. For example, a liquid polymer can be injected into a mold defining a cavity. A core portion of a golf ball can be substantially centered relative to the cavity. A plurality of spaced-apart radial film gates can be circumferentially positioned relative to the cavity. The liquid polymer can be conveyed into the cavity and through the plurality of radial film gates, and into a volume defined between the core portion and the mold. The conveyed liquid polymer can form a substantially uniformly distributed polymer layer. The polymer layer can be allowed to solidify. A golf ball construct having been so formed can be removed from the mold cavity.

The plurality of radial film gates can comprise four radial-film gates. The four radial film gates can occupy between about 45 percent and about 90 percent of a major circumference of the cavity. The polymer can be one of an ionomer, a thermoplastic polyurethane and a thermosetting polyurethane.

The solidified polymer layer can comprise an outer layer of the golf ball construct, and have a maximum thickness between 0.010 and 0.100 inch, preferably 0.015 and 0.080 inch, more preferably about 0.020 and about 0.060 inch, and most preferably about 0.025 inch and about 0.045 inch. In other instances, the polymer layer comprises an inner layer of the golf ball construct.

Disclosed radial film gates can define an opening having a non-uniform thickness. The non-uniform thickness can form a taper between opposing ends of the opening. In other instances, at least one step separates a first region having a first thickness from a second region having a second thickness.

Injection molds for manufacturing golf balls are also disclosed. Such molds can, comprise at least one substantially spherical cavity region having a major circumference and defining two corresponding opposed pole regions. A plurality of spaced-apart radial film gate regions can adjoin the cavity region and be so positioned relative to the cavity region as to define at least one line of substantial symmetry. A plurality of core pins can retain a golf ball core in a substantially centered position relative to the cavity region. At least one vent region can be defined adjacent each opposed pole region.

In some disclosed molds, at least one of the radial film gate regions defines a non-uniform gate thickness. For example, the at least one of the radial film gate regions can comprise first and second gate portions defining first and second gate thicknesses, respectively. A runner portion can be fluidly coupled to the at least one of the radial film gate regions. The first gate portion can be proximately positioned relative to the runner, and the second gate portion can distally positioned relative to the runner portion. The second gate portion can be thicker than the first gate portion.

Some disclosed molds define a plurality of cavity regions. For example, the at least one substantially spherical cavity region can comprise four substantially spherical cavity regions.

Golf balls are also disclosed. Such golf balls comprise a dimpled thermoplastic polymer outer cover having a maximum thickness not greater than about 0.055 inch, such as not greater than about 0.045 inch. The cover substantially uniformly surrounds a core, and can be formed by a disclosed method. For example, such a method can comprise melting a thermoplastic resin and conveying the thermoplastic resin through a plurality of radial film gates into a cavity so as to form the outer cover. The outer cover can be cooled, and the ball can be removed from the cavity.

Mold inserts are also disclosed. For example, this disclosure describes at least one of a plurality of operatively arrangeable injection-mold inserts, each of the plurality of inserts being configured to operatively engage at least one other of the plurality of injection mold inserts. When operatively arranged, the plurality of inserts defines a substantially spherical cavity for injection molding a layer of a golf ball construct. One of the plurality of injection mold inserts can comprise a recessed cavity region defining at least a portion of the substantially spherical cavity. The insert can also comprise a mating surface configured to matingly engage a corresponding mating surface of another of the injection mold inserts in the plurality. The insert can also comprise a recessed runner region adjoining the mating surface and having a runner surface being recessed from the mating surface by a first distance. A recessed radial film gate region can adjoin the mating surface and define at least one corresponding gate surface. The gate surface can be recessed from the mating surface. The radial film gate region can be positioned between and adjoin the recessed runner region and the recessed cavity region. The gate surface can be recessed from the mating surface by a distance less than the first distance.

In some disclosed injection mold inserts the radial film gate region is recessed from the mating surface by between about 0.010 inch and about 0.030 inch.

The gate surface can be uniformly recessed from the mating surface. In other inserts, the gate surface comprises a first gate surface, and the recessed radial gate region defines a second gate surface also being recessed from the mating surface. The first gate surface and the second gate surface can be separated by a step. A substantially continuous taper can join the first gate surface and the second gate surface. The recessed gate region can comprise two spaced-apart and recessed end regions and a center region extending between the end regions. At least one end region can adjoin the mating surface and separate the center region from the mating surface.

Disclosed recessed cavity regions of inserts can adjoin a vent aperture. When the plurality of injection mold inserts are operatively arranged, a pole of the substantially spherical cavity can extend through the vent aperture.

Other embodiments of injection molds for forming a layer of a golf ball construct are disclosed. Some molds comprise a plurality of mold portions defining respective recessed regions being so configured as to define a substantially spherical cavity when the plurality of mold portions are operatively arranged. These molds also comprise a portion of a runner system configured to convey an injection material, and a plurality of radial film gate portions. The radial film gate portions can be configured to fluidly couple the runner system and the substantially spherical cavity, and to convey the injection material therebetween. Each radial film gate portion can define a gate opening having a width-to-thickness ratio of at least 4:1.

In some molds, each of the plurality of mold portions comprises a respective mold insert. Other molds comprise no inserts, and in other molds, some mold portions comprise an insert while others do not. Disclosed mold inserts can define a portion of one or more of the plurality of radial film gate portions.

Radial film gate portions can be so positioned as to occupy a substantially common plane in spaced apart relation to each other and to occupy less than about 90% of a major circumference of the substantially spherical cavity.

The foregoing and other features and advantages will become more apparent from the following detailed description, which proceeds with reference to the accompanying figures.

### BRIEF DESCRIPTION OF THE DRAWINGS

FIG. 1 shows a side elevation view of a golf ball having layers partially removed to reveal interior features.

FIG. 2 is a top plan view of a schematic diagram of a disclosed mold. Shown in FIG. 2 are a sprue, runners and cavities.

FIG. 3 is a detailed view of one of the cavities shown in FIG. 2.

FIG. 4 is a cross-sectional view of an exemplary radial film gate.

FIG. 5 is an isometric view of a mold insert defining a recessed region.

FIG. 6 is a cross-sectional view of a core positioned within a mold cavity.

FIG. 7a is a front elevation view of an exemplary gate opening projected on a plane.

FIG. 7b is a front elevation view of another gate opening projected on a plane.

FIG. 7c is a front view of a tapered gate opening projected on a plane.

FIG. 7d is a front view of a gate opening with two steps projected on a plane.

FIG. 7e is a front view of a gate opening with tapered end regions projected on a plane.

FIG. 8 is a top plan view of a schematic diagram of a mold cavity fed by four separate radial film gates fluidly coupled to a single primary runner.

FIG. 9 is a cross-sectional view of a closed mold showing a primary runner in direct fluid communication with a radial film gate.

FIG. 10 is a top plan view of a schematic diagram of a mold cavity having a pair of opposed radial film gates.

FIG. 11 is a top plan view of a schematic diagram of a mold cavity having three radial film gates positioned on a circumference of the cavity.

FIG. 12 is a cross-sectional view of a radial film gate having a tapered opening between sloped upper and lower surfaces.

FIG. 13 is a top plan view of a schematic diagram of a prior art mold showing an uneven and imbalanced flow field.

FIG. 14 is a top plan view of a schematic diagram of an exemplary disclosed mold cavity having a symmetric arrangement of radial film gates providing a balanced flow field.

### DETAILED DESCRIPTION

The following discloses systems for injection molding one or more layers of a golf ball. Some disclosed systems provide balanced flow fields of injection material, making thin injection-molded layers possible that heretofore have not been possible. As described more fully below, some disclosed systems provide a plurality of spaced-apart radial film gates configured to symmetrically inject an injection material into a mold cavity. In some systems, such symmetric injection balances pressures and forces applied to a golf ball core during injection and can produce a thin layer. In some implementations, a cover layer or a mantle layer measuring between about 0.025 inch and about 0.045 inch is produced using an injection material having a melt flow index greater than or equal to 10. In some implementations, a cover layer or a mantle layer measuring between about 0.025 inch and about 0.055 inch is produced using an injection material having a melt flow index less than 10. As used herein, “melt flow index” means the unit of measure specified in the American Society for Testing and Materials (ASTM) standard no. D1238-04 using a temperature of 230 degrees Celsius (° C.) and a 2.16 Kg mass.

### System Embodiments

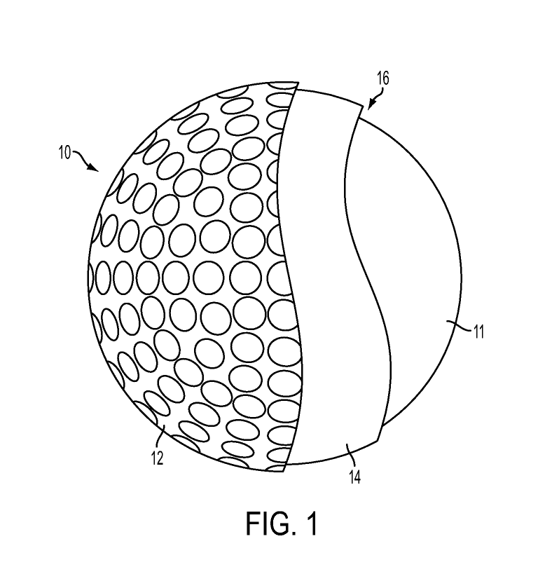

With reference to FIG. 1, a golf ball 10 typically includes an outer cover 12 and one or more internal layers 14, 16. The outer cover 12 can comprise a polymeric layer. At least one mantle layer 14 can lie beneath the cover 12, and above one or more other layers forming a portion of the core 16 of the ball. Alternatively, a golf ball 10 can comprise an outer cover 12 comprising a polymeric layer and a unitary core 16 (e.g., without any intermediate mantle layer). The disclosed systems are suitable for forming the outer cover 12, the mantle layer 14, and other polymer layers of golf balls.

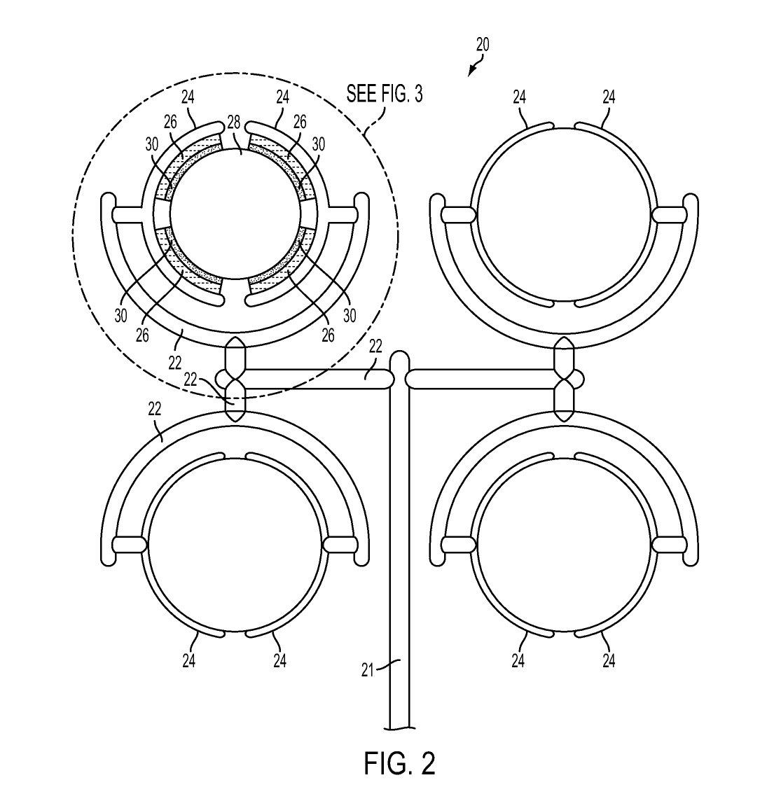

With respect to FIG. 2, a viscous polymer (e.g., liquid or molten-state polymer) can flow into the mold 20 through the sprue 21 and be conveyed through the runner system 22 toward one or more individual cavities 28. The runner system 22 comprises runner channels that convey a liquid polymer from the sprue 20 to the respective primary runners 24 and radial film gates 30.

FIG. 2 shows a cold sprue and cold runner configuration. In the other embodiments, a viscous polymer can be conveyed to the mold 20, and through the runner system 21 using any suitable configuration, such as, for example, a hot runner, a hot sprue, or any other conventional runner system known in the art.

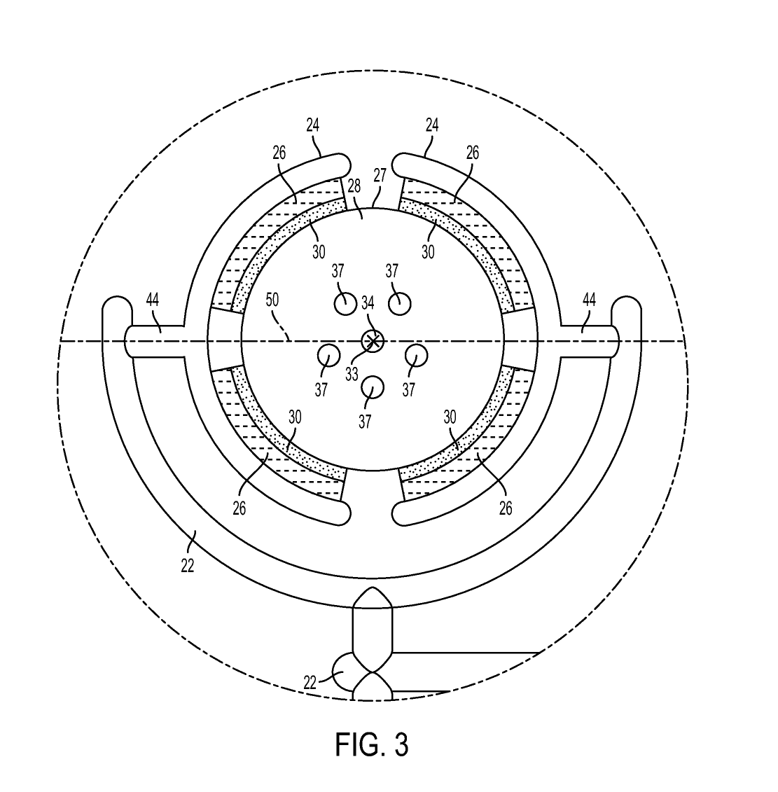

The sprue 20, runners in the runner system 22, and the primary runner 24 can each have a substantially circular cross-section. Injection material (e.g., polymer, ionomer, polyalkenamer composition, post-curable resin or thermoset plastic) can flow into a primary runner 24 from the runner system 22. As shown in FIGS. 2 and 3, the primary runners 24 can be circumferentially positioned relative to and radially spaced from a portion of a corresponding cavity 28. Polymer flows into the primary runners 24 from the runner system 22 through a runner portion 44 that is perpendicular and centrally located relative to a primary runner. Each primary runner 24 can convey polymer to one or more sub-runners 26 (e.g., two corresponding sub-runners, as shown in FIG. 3). Each sub-runner can convey injection material into a radial film gate 30, opening to a corresponding mold cavity 28. In the embodiment shown in FIGS. 2 and 3, four radial film gates 30 are spaced about a circumference of the cavity 28 and fed by two primary runners 24.

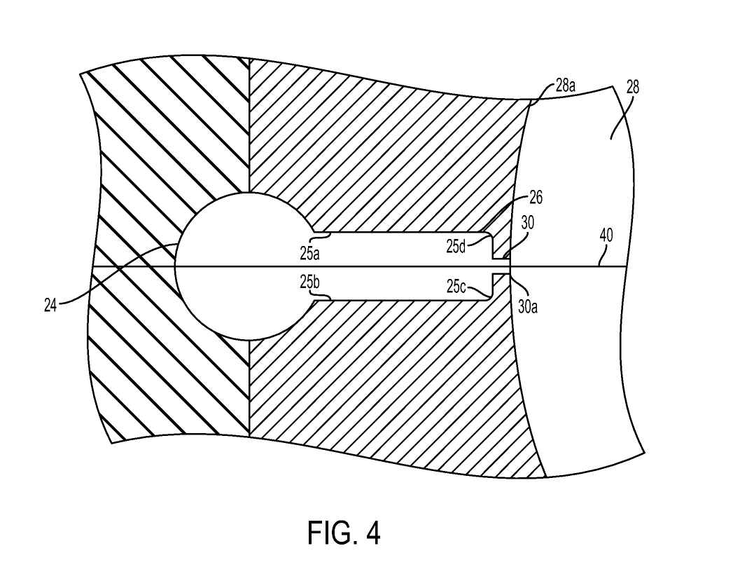

Referring to FIG. 4, an intersection of a primary runner with the sub runner 26 is shown in cross-section. The radial film gate 30 extends inwardly toward the cavity 28. The primary runner 24 defines a substantially circular or rounded cross-section, and opens to a sub runner 26 having a rectangular cross section with flat and parallel upper and lower major surfaces 25a, 25b. Respective radiuses 25c, 25d join end walls of the sub-runner 26 to the upper and lower walls 25a, 25b. The end walls define an opening to the radial film gate 30, such that an injection material can flow from the sub-runner 26 into the gate 30. The wall 28a of the cavity defines an opening 30a from the gate 30 through which the injection material can flow into the cavity 28. As shown in FIG. 3, the radial film gate 30 can extend along the full length of a corresponding sub-runner 26.

Referring again to FIG. 2, each cavity 28 is fed by two primary runners 24 feeding two respective sub-runners 26. Each respective sub-runner feeds a single corresponding radial film gate 30. As shown in FIG. 3, four radial film gates 30 are approximately evenly spaced about the circumference 27 of the cavity 28. As disclosed more fully below, such an arrangement of runners, gates and cavities can provide a balanced (e.g., substantially symmetric) flow field of injection material and provide thin, injected-molded layers for golf balls.

For example, with reference to FIG. 3, a cavity 28, a runner system 21, and a plurality of radial film gates 30 define a line of symmetry 50 extending through the approximate center of the substantially spherical cavity and the runner portions 44. In addition, the film gates 30 are positioned in a substantially axisymmetric arrangement about an axis 33 running between the poles of the cavity 28. Forces applied to a core during injection can be substantially balanced (or symmetric) by using such a symmetric configuration of radial film gates 30 and runners, improving the ease with which the core 16 can be retained in a centered position relative to the cavity.

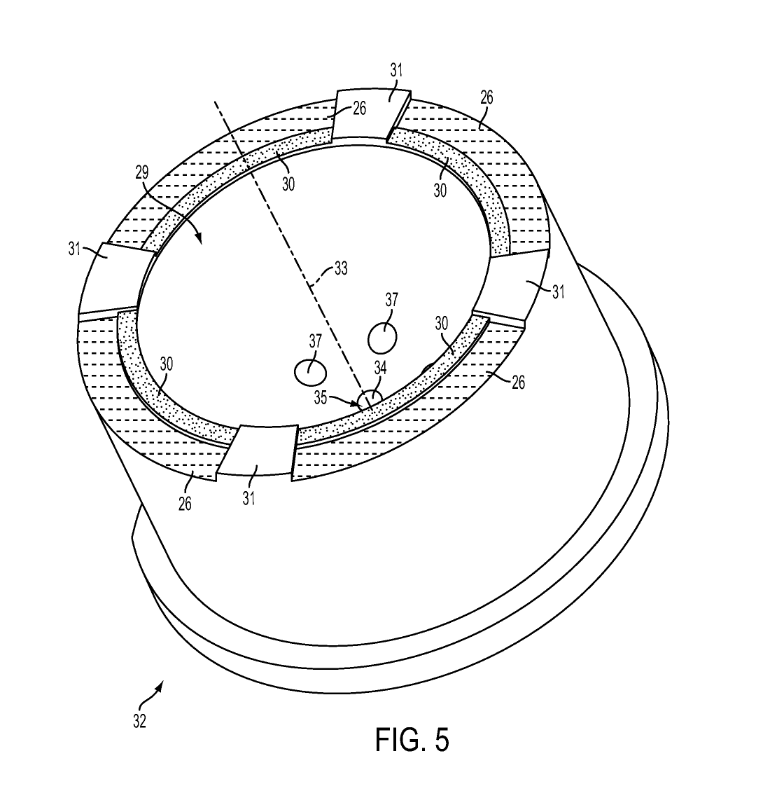

With reference to FIG. 5, an insert 32 can define a hemispherical recessed portion (or region) 29 defining the cavity 28. A pair of inserts 32 can be positioned in an opposing relationship with respective mating surfaces 31 engaged so as to define a substantially spherical cavity. A wall 28a (FIG. 4) of the recessed portion 29 can be textured with internally extending bumps (not shown) for forming a dimple pattern in an injected layer (e.g., the external surface of the outer layer 12 (FIG. 1)). Each insert 32 can also define other recessed regions to form each radial film gate 30. In the exemplary embodiment, the surfaces of the inserts 32 that are exposed to each other are mirror images of each other.

The insert 32 shown in FIG. 5 has a unitary construction and is preferably made from an alloy of tool steel. Other inserts comprise multiple parts coupled together. Some molds (not shown) comprise the recessed features and do not incorporate any removable inserts 32.

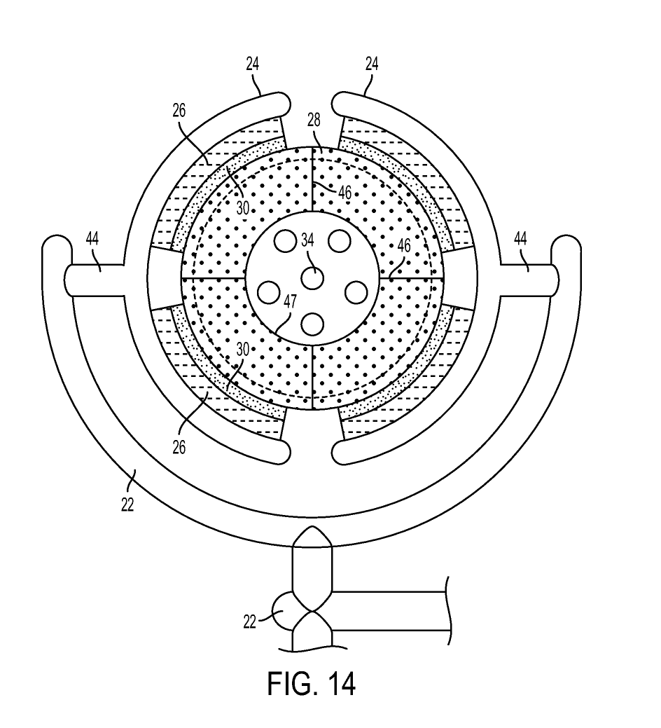

An axis 33 extends between and through each pole 35 of the spherical cavity 28. An aperture can be formed adjacent each pole 35 to define a vent 34. In some embodiments, the vent 34 is positioned in alignment with the axis 33 such that the axis 33 is coincident with a longitudinal axis extending through the vent. As discussed more fully below, the vent 34 can be so positioned relative to a convergence point (not shown) of an injection material flow front 47 (FIG. 14) as to vent all, or substantially all, gas from the cavity 28 as the injection material fills the cavity 28.

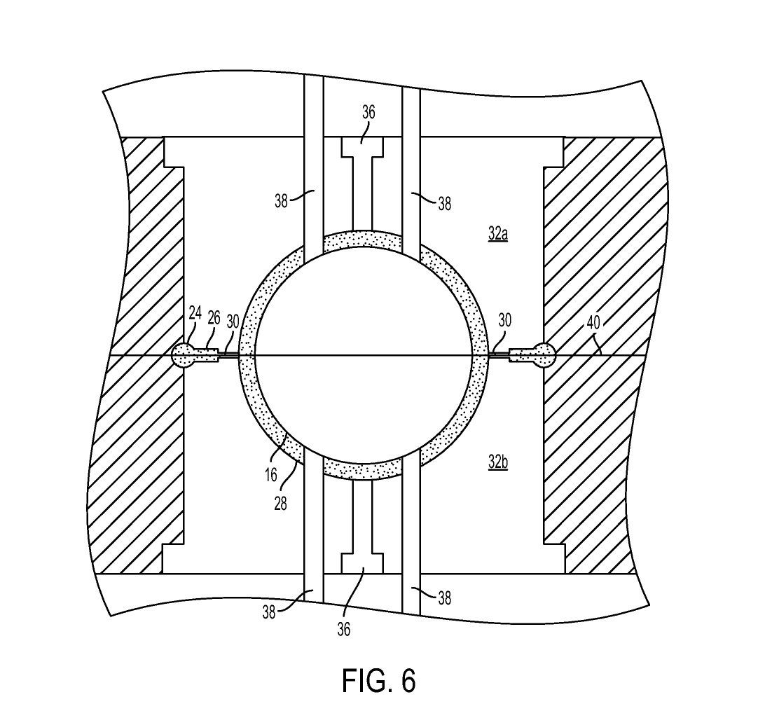

A vent pin 36 (FIG. 6) can longitudinally extend through the aperture such that a longitudinal axis of the vent pin lies parallel to the axis 33. In some instances, the longitudinal axis of the vent pin is coincident with the axis 33. FIG. 5 also shows several core pin holes 37 adjacent the vent 34. A core pin can extend through each respective core pin hole 37. Such core pins can support a core 16 (FIG. 1) in a centered position relative to the cavity 28. Some embodiments have more than or fewer than the five core pin holes 37 shown in FIGS. 3 and 5 per hemisphere.

Referring now to FIG. 6, a core 16 can be centrally retained within a spherical cavity 28 by core pins 38. During a molding process, a polymer layer can be injected into the open volume defined between the inserts 32a, 32b and the core 16. Each of the core pins 38 can retract during injection of an injection material, allowing the material to flow completely around the core 16 and form a corresponding enclosed polymeric layer surrounding the core. After the layer has solidified (e.g., the injected layer has cooled), the core pins 38 can be extended to assist in ejecting the part from the mold.

In FIG. 6, a first mold portion 32a and a second mold portion 32b define a mold cavity 28 configured to form an outer cover 12 of a golf ball 10 (FIG. 1). The portions 32a, 32b matingly engage each other at a substantially common plane (or along a “parting line”) 40. Each radial film gate 30 is substantially parallel to the parting line 40 and occupies respective portions of the common plane. The parting line 40 defines a vertical line of symmetry for the respective radial film gates 30, sub-runners 26, and primary runners 24. In the embodiment shown in FIG. 6, the parting line 40 is oriented horizontally. In alternative embodiments, the parting line 40 is oriented vertically.

In practice, a polymer (or other injection material) can be injected into the volume defined between the core 16 and the cavity walls of the insert portions 32a, 32b. When using injection materials having a melt flow index greater than or equal to 10, the cavity 28 can be sized relative to the core 16 so as to form a maximum thickness of about 0.025 inch to about 0.045 inch (for example, 0.030 inch) after the injection material has substantially solidified (e.g., cooled). Alternatively, when using an injection material having a melt flow index less than 10, the cavity 28 can be sized relative to the core 16 so as to form a maximum thickness of about 0.025 inch to about 0.055 inch (for example, 0.040 inch). In the context of a dimpled outer cover 12 of a golf ball, “maximum wall thickness” means the distance between the core 16 and an outer most surface of the cover 12, which typically corresponds to an interstice or land located between adjacent dimples.

Disclosed molds can be configured to form a mantle layer 14, or other intermediate layer, of a golf ball. In such embodiments, the cavity 28 can be sized relative to the core 16 so as to form a layer having a desired wall thickness.

Following injection of a polymer (or other injection material) into the cavity 28, a hold pressure can be applied for a certain duration (or “hold time”) to ensure that a suitable amount of material flows into the cavity and/or to inhibit the material from flowing back into the runner system 22. A golf ball (or other construct) can be retained in the cavity 28 for a period of time so as to allow the molded layer to adequately harden (or solidify) before being removed from the mold. One or more ejector pins can advance into the cavity and/or past the parting line 40 to assist with removal of the golf ball and/or the runners. The molded construct(s), along with any runners or sprues formed during the molding process, can be removed from the mold by hand, by a robot, by the injection molding machine, by the force of gravity, or by other known and/or equivalent techniques. After the construct(s) have been removed, individual pieces (e.g., golf balls) can be mechanically separated from the runner system and/or undergo other finishing operations (e.g., to remove residual gate vestige from an outer surface).

A variety of polymers (or other injection materials) are suitable for use with disclosed molds and methods for forming injection molded outer covers and/or mantle layers 16. Some injection materials comprise polymers that are reinforced with fibers or fillers.

Regarding the outer cover, some suitable materials include ionomeric polymers, such as those resins marketed under the Surlyn® and HPF marks owned by the E. I. du Pont de Nemours and Company (DuPont), amine-modified ionomers, ionomeric copolymers and blends, thermoplastic polyurethanes and other polymers.

Examples of injection materials that are suitable for forming a mantle layer include elastomeric thermoplastic polymers, such as, for example, thermoplastic rubbers (e.g., polybutadiene), ionomers (e.g., Surlyn® and HPF materials), and synthetic elastomeric tri-block copolymers, (e.g., Hytrel®,marketed by DuPont, Pebax® marketed by Arkema and polyurethanes). Additionally, some systems are suitable for molding thermosetting polymers, including RIM formulations, to form an outer cover and/or inner layer of a golf ball.

Other injection materials are also possible, such as, for example, those disclosed below, and those disclosed in U.S. Patent Publication 2009-0209367-A1, published Aug. 20, 2009, assigned to the assignee of this application, and incorporated herein by reference in its entirety. Some examples of such injection materials include polymeric materials generally considered useful for making golf balls, including, without limitation, synthetic and natural rubbers, thermoset polymers such as thermoset polyurethanes and thermoset polyureas, as well as thermoplastic polymers including thermoplastic elastomers. Any isocyanate, polyol, or polyamine is suitable for use as an injection material. Diisocyanate and polyol or polyamine components may be previously combined to form a prepolymer prior to reaction with a chain extender or curing agent in producing acceptable injection materials.

In view of the aforementioned advantages of injection molding versus the more complex casting process, under some circumstances it is advantageous to have formulations which are able to cure as a thermoset but only within a specified temperature range which is above that of the typical injection molding process. This allows parts, such as golf ball cover layers, to be initially injection molded, followed by subsequent processing at higher temperatures and pressures to induce further crosslinking and curing, resulting in thermoset properties in the final part. Such an initially injection moldable composition is thus called a post curable urethane or urea composition.

If a post curable polyurea or polyurethane composition is used, a modified or blocked diisocyanate which subsequently unblocks and induces further cross linking post extrusion may be included in a diisocyanate starting material. Such a system is disclosed by Kim et al in U.S. Pat. No. 6,939,924, the entire contents of which are hereby incorporated by reference. Alternatively, a thermoplastic urethane or urea composition further comprising a peroxide or peroxide mixture can result in a thermoset. Such a system is disclosed by Kim in U.S. Pat. No. 6,924,337, the entire contents of which are hereby incorporated by reference. Thermoplastic urethane or urea compositions may further comprise a reaction product of a nitroso compound and a diisocyanate or a polyisocyanate to induce further cross linking post extrusion may be included in the diisocyanate starting material. Such a system is disclosed by Kim et al in U.S. Pat. No. 7,037,985 B2, the entire contents of which are hereby incorporated by reference.

### Alternative Embodiments

The mold 20 shown in FIG. 2 has four cavities although a different number of cavities is possible (e.g., the mold 20 can define fewer than four cavities (e.g., two or three cavities), or more than four cavities (e.g., five, six, seven or eight cavities, or molds). A larger number of cavities can increase manufacturing throughput, but can also lead to a process that is more difficult to control. To achieve a balanced flow field, symmetric molds (e.g., an even number of cavities) can be used.

In some embodiments, a Meltflipper® insert (available from Beaumont Technologies Inc. of Erie, Pa.) or other, similar apparatus can be used at runner junctions for improving flow and balance through the runner system (e.g., reducing pressure gradients within the system). Adjustable inserts at runner junctions can act as valves to alter flow rate to corresponding portions of a runner system (by imposing a local pressure gradient). Such valves can also close to prevent injection material from flowing to a corresponding portion of the mold (e.g., to prevent flow to a damaged cavity). Various runner cross-sections can be employed, including, for example, a circular, semi-circular, square, trapezoidal, or other cross-sectional shape.

For example, a hot runner system, a hot sprue system, a cold sprue and runner system or combinations can convey polymer to disclosed molds. Polymer injection can be parallel to or perpendicular to a parting line of the mold, and an injection apparatus can be oriented vertically or horizontally. If a cold runner system is used, flow-improvement devices can be used (e.g., a Meltflipper® insert located at a runner junction). The precise dimensions and characteristics of disclosed embodiment can be selected based, at least in part, on several parameters, including the number of cavities, the polymer material, and the injection molding machine being used.

Substantially uniform spacing among gates have been described above. Other molds have non-uniform spacing between adjacent gates. Such non-uniform spacing can depend, in part, on the number, size and/or shape of the runners and/or gates. Configurations of sprue and runner systems can depend on a number of variables, including for example, the number of cavities in a particular mold, the number of gates for each cavity, the size of the mold, the configuration of the injection molding machine used to drive the injection material, the desired configuration of the layer that is being formed, and the injection material used. For example, in a single cavity embodiment, a sprue can directly couple to a primary runner.

Preferably, in at least some injection mold inserts the radial film gate region is recessed from the mating surface by about 0.010 inch and about 0.030 inch. Each radial film gate portion preferably defines a gate opening having a width-to-thickness ratio of at least 4:1.

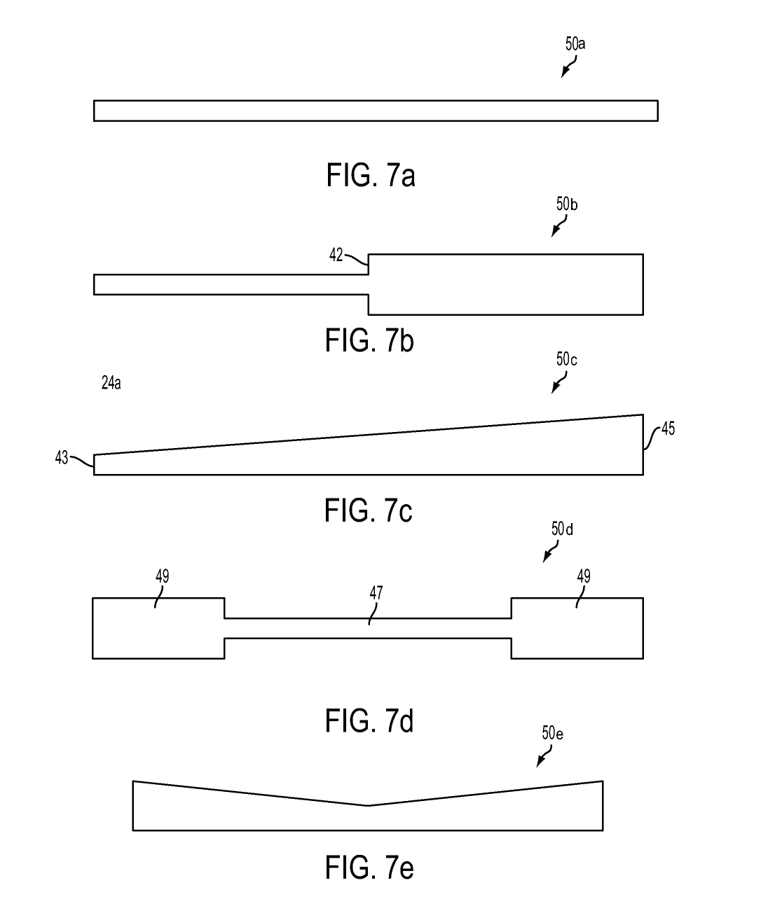

For ease of illustration, molds, runner systems and cavities have been discussed above in combination with a uniform thickness (i.e., opening or dimension) radial film gate 50a of the type shown in FIG. 7a. Nonetheless, a variety of radial film gate configurations is possible, as shown in FIGS. 7b, 7c, 7d and 7e.

For example, a gate configuration shown in any of FIGS. 7b-7e (or a gate having an arbitrary shape) can be substituted for any of the uniform-thickness gates shown in connection with any of the mold and/or system embodiments shown and described herein. For example, the gate 50b shown in FIG. 7b has two distinct thicknesses separated by a step 42. In FIG. 7c, the shape tapers from a narrow end 43 to a broad end 45 (e.g., the gate 50c has a tapered opening). Referring to FIG. 3, a gate having a broad end and a narrow end (e.g., the gate 50b in FIG. 7b or the gate 50c in FIG. 7c) can be oriented relative to the cavity 28 and primary runner 24 so as to position the broad end of the respective gate adjacent a distal end (relative to a runner portion 44) of the primary runner 24, thereby locating the broad end adjacent a point furthest along the injection material's flow path (e.g., a distal end of a runner). Such a configuration can at least partially relieve pressure gradients in an injection material flow field providing a substantially balanced flow field into the cavity (and/or among cavities). Gate configurations shown in FIGS. 7b and 7c are well-suited for use in mold configurations having a runner portion 24 feeding spaced apart radial film gates 30 (FIG. 14).

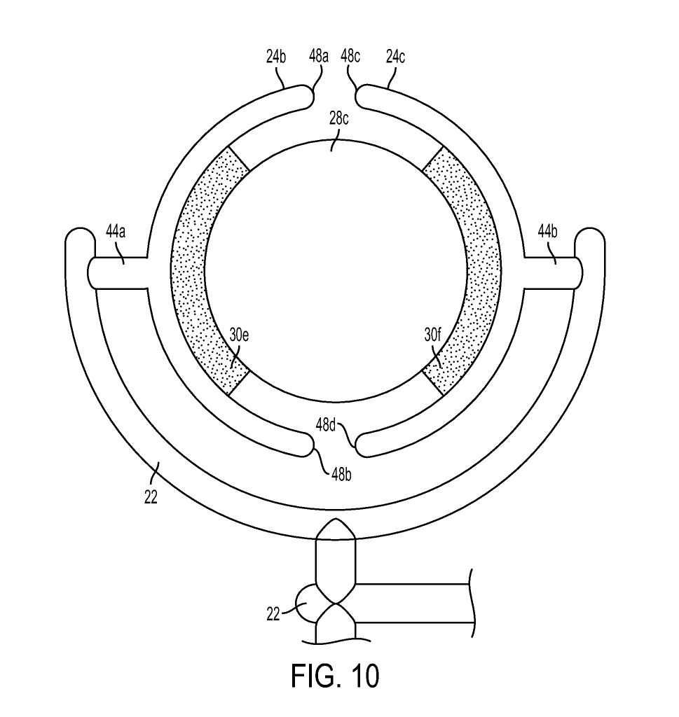

Still other gate configurations are possible. For example, FIG. 7d shows a gate 50d having thick ends separated by a narrow region. A step at each of the opposing ends of the narrow region opens to the corresponding thick end. FIG. 7e shows another gate example. The gate 50e shown in FIG. 7e has thick ends that taper toward a central region. Gate configurations shown in FIGS. 7d and 7e are well-suited for use in mold configurations having a single radial film gate 30 fed by a runner portion 24 to a middle region (FIG. 10 of the gate). In general, gate thickness (i.e., the size of the opening) can vary linearly or according to a higher-order polynomial or randomly.

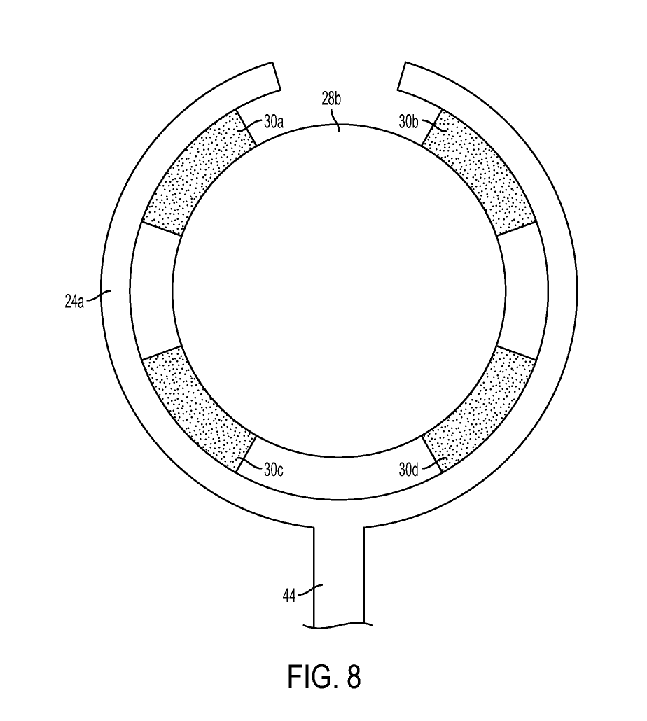

Referring to FIG. 8, a single-runner configuration is shown. In FIG. 8, a portion of a mold comprising a mold cavity 28b, a primary runner 24a, four radial film gates 30a, 30b, 30c, 30d and a runner portion 44 is shown. The mold portion shown in FIG. 8 can comprise the only cavity formed in the mold (e.g., the mold can be a single-cavity mold), or the mold portion shown in FIG. 8 can comprise but one of several cavities (e.g., the mold can be a multi-cavity mold), similar to the mold shown in FIG. 2.

Referring still to FIG. 8, the single runner portion 44 fluidly couples the primary runner 24a to the runner system (not shown). The primary runner 24a is spaced from, and arcuately extends around, a majority (e.g., between about 70% and about 95%, such as between about 75% and about 85%) of the cavity 28 circumference. Four spaced-apart radial film gates 30a, 30b, 30c, 30d extend radially inward toward the cavity 28 from the primary runner 24a and fluidly couple the cavity with the primary runner. The radial film gates 30a, 30b, 30c, 30d can have a substantially identical configuration (e.g., a configuration shown in FIGS. 7a-7e), or the radial film gates can be configured differently from each other.

A single-runner configuration of the type shown in FIG. 8 having identical radial film gates can give rise to pressure gradients along the primary runner 24a (e.g., between the runner portion 44 and the distal radial film gates 30a, 30b). Such pressure gradients can produce an uneven flow field through the gates 30a, 30b, 30c, 30d (e.g., a flow rate of an injection material through the gates 30a, 30b can differ from a flow rate through the gates 30c, 30d). A non-uniform flow field through the radial film gates can produce an uneven distribution of injection material (e.g., an unbalanced flow) within the cavity 28, leading to defective injection molded parts (e.g., finished parts having pronounced knit lines).

In some mold portions of the type shown in FIG. 8, such pressure-gradient related effects, to the extent they are present, can be alleviated by configuring the distally positioned radial film gates 30a, 30b differently from the proximally positioned radial film gates 30c, 30d. For example, the distally positioned radial film gates 30a, 30b can define larger or smaller respective flow cross-sections than the proximally positioned radial film gates 30c, 30d and/or the gate thickness can vary along its width (FIGS. 7b, 7c). Such differently sized flow cross-sections can be provided by adjusting respective gate thickness and/or gate width. For example, a larger opening can be provided by making a gate thicker and/or wider.

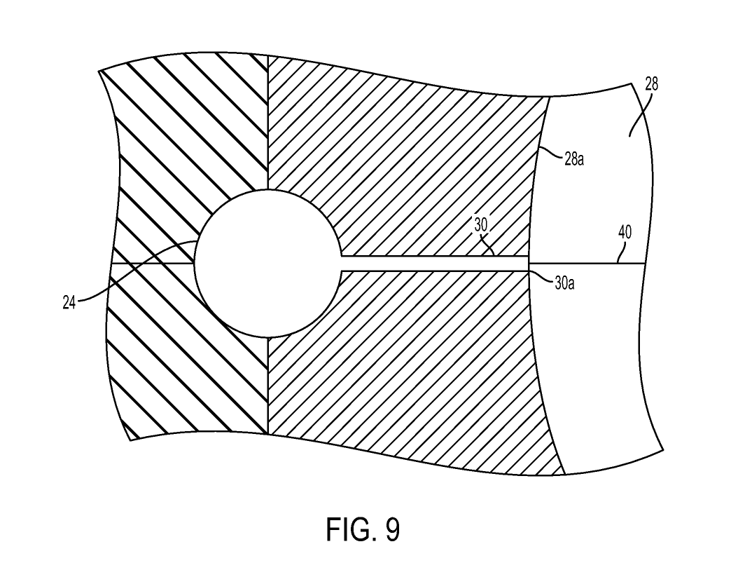

As shown in FIG. 9, some embodiments do not use a sub-runner and instead feed the radial film gates 30 directly from a primary runner 24.

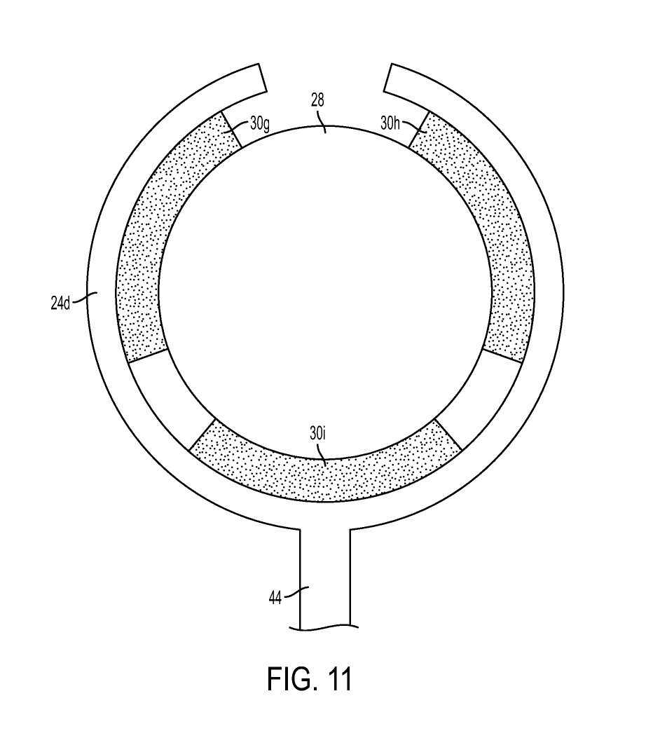

Cavities of a given mold can be fed by fewer than four (or more than four) radial film gates. For example, a cavity can be fed by two radial film gates 30 (FIG. 10), three radial film gates (FIG. 11), or more radial film gates.

Referring to FIG. 10, a portion of a mold having a cavity 28c fed by first and second primary runners 24b, 24c is shown. Each primary runner 24b, 24c is fed by a respective runner portion 44a, 44b, as shown. The fluid coupling between each primary runner and each respective runner portion is positioned at about a mid-point between opposing distal ends 48a, 48b and 48c, 48d of each primary runner. One radial film gate 30e, 30f extends radially inward from each respective primary runner 24b, 24c, as shown. As with the cavity/runner configuration shown in FIG. 8, pressure gradients between the runner portions 44a, 44b and the distal end 48a, 48b, 48c, 48d of the primary runner can sometimes impart a non-uniform flow field through the radial film gates 30e, 30f. To mitigate any deliterious effects of such pressure gradients (and/or mitigate the pressure gradients themselves), the radial film gates 30e, 30f can each have a non-uniform gate thickness (e.g., the gate shape can differ along its width, such as, for example, is shown and described in relation to FIGS. 7d and 7e).

In FIG. 11, a portion of a mold having a cavity fed by three radial film gates 30g, 30h, 30i and a single primary runner is shown. As with the single primary runner system shown in FIG. 8, pressure gradients among (and within) the radial film gates 30g, 30h, 30i (particularly if they are identically configured) can sometimes impart a non-uniform flow field in the cavity 28. To mitigate any ill effects of such pressure gradients (and/or mitigate the pressure gradients themselves), the radial film gates 30g, 30h, 30i can each have a non-uniform gate thickness. For example, the radial film gate 30i can have a substantially symmetrically varying gate thickness (or gate shape) (FIGS. 7d, 7e), and the radial film gates 30g, 30h can define a gate opening of a different size (and/or shape) from the gate 30i (FIGS. 7b, 7c).

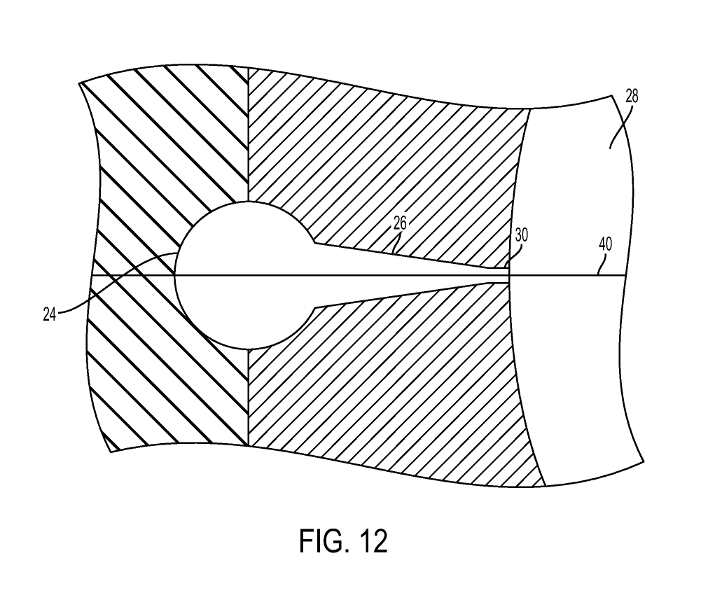

Depending on the particular configuration, the combined total width of the gates corresponding to one cavity can range from about 45% to about 90% of the major circumference (e.g., an equator) of the respective cavity. Some gate configurations occupy more than about 75% of the circumference. The gate land length (e.g., a longitudinal flow length through the gate) can vary among gates in a mold (e.g., from cavity to cavity within the same mold, and/or from gate to gate corresponding to the same cavity) so as to achieve a particular flow field (e.g., a symmetric, or balanced, flow field). Gate land lengths can range from about 0.020 inch to about 0.180 inch, such as between about 0.020 inch and about 0.040 inch. Gate surfaces can define a draft (or a tapering flow channel), and such drafts or tapers can vary among gates in a given mold. For example, FIG. 12 shows an example of a radial film gate 30 having upper and lower surfaces forming a tapering flow cross-section (in contrast to a tapered opening, as shown in FIG. 7c).

Alternative vent configurations can be used to vent a cavity. If a vent pin is used, the pin can be formed from a tool steel alloy and/or from a porous material, such as the material described in U.S. Pat. No. 6,776,942, which is incorporated herein by reference. The body of the vent pin can have a substantially cylindrical, substantially rectangular, or some other cross-sectional shape. Some inserts comprise a plurality of separate pieces with at least one vent channel defined at a junction of two or more of the pieces.

In some molds for molding a mantle layer 14 (FIG. 1), a radial film gate can have a thickness of less than about 0.060 inch. In other embodiments (e.g., for molding an outer cover 12), a radial film gate can have a thickness ranging from about 0.010 inch to about 0.040 inch, such as between about 0.010 inch and about 0.020 inch. Some thinner gates better accommodate a dimpled pattern of an outer cover, and can form easier-to-remove vestiges. Gate thickness can vary among gates in a given mold, among gates corresponding to a given cavity, and even within a given gate (FIGS. 7b-7e).

As described above, variations in gate thickness can alleviate pressure gradients relative to gates having a uniform gate thickness. More uniform pressures within an injection material can provide more uniform flow rates of injection material through different portions of a gate or among various gates coupled to a given portion of a runner system 22.

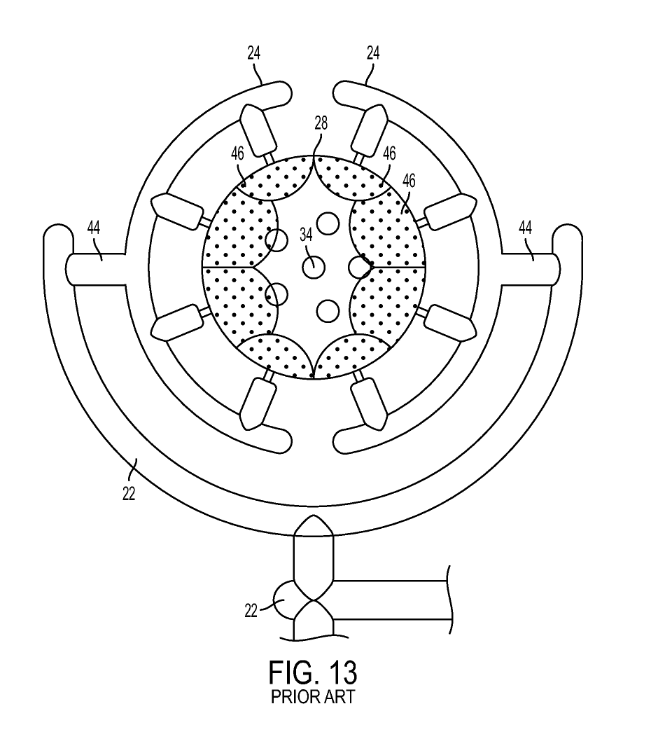

By way of example, FIG. 13 shows an unbalanced flow field in a mold having eight conventional and uniformly configured edge gates. With such a mold configuration, the flow of injection material typically progresses fastest near the gates closest to the runner portion 44 and slowest near the gates furthest from the runner portion. Such a non-uniform flow (or flow field) in the cavity can result in pronounced knit lines 46 and/or poor control over the location of the flow path terminus, and possibly even a terminus positioned away from the vent, leading to further defects. For example, a flow field as shown in FIG. 13 can define two distinct flow terminuses. Conventional molds can lead to one or both terminuses being positioned apart from a vent location 34, trapping gas in the cavity upon completion of the injection cycle and producing a defective layer and/or golf ball.

In contrast to such conventional systems, radial film gates of the type disclosed herein can provide a more balanced flow progression (and a corresponding more evenly distributed molded layer). For example, a non-uniform radial film gate thickness can make a fill rate more uniform (e.g., around latitudes of a cavity), providing a more balanced and even flow progression of the type shown in FIG. 14. The flow front shown in FIG. 14 evenly progresses towards a single flow front terminus adjacent the vent location 34 (e.g., a pole) in each hemisphere. Among the many advantages of using radial film gates as opposed to conventional edge gates, radial film gates can reduce the number of knit lines and balance flow progression, and in turn produce parts, such as golf balls having fewer manufacturing defects than conventional gates having non-uniform openings (e.g., variable thickness).

The number of gates feeding the corresponding cavity, the number and size of runners feeding each gate, characteristics of the injection material and location of the runners relative to the gates can affect injection material flow rate and fluid shear. Radial film gates as disclosed herein (e.g., a gate with a non-uniform thickness) can tune such fill characteristics to provide, among many finished parts, golf balls having thin, injection-molded, polymer covers.

Commercially available finite element or finite difference software, such as, for example, Moldflow (available from Autodesk Inc. of San Rafael, Calif.), can be used to analyze the effects of, for example, gate thickness, runner configuration and cavity configuration (e.g., parametric studies based on variations in gate dimension, runner configuration, and cavity configuration) on the flow field of an injection material. The results of such analyses can be used to evaluate combinations of gate, runner and cavity configurations.

Radial film gates can be well-suited to variations in thickness, unlike conventional gate configurations. For example, edge gates have less cross-sectional area across which a variation in thickness can be defined, in part making it difficult to sufficiently vary opening dimensions so as to affect a flow field with the cavity. In contrast to annular ring gates, a radial film gate corresponds to a smaller portion of the cavity, allowing more of the mold to be preserved in case of a gate defect (as compared to a mold having annular ring gates). On the other hand, a radial film gate corresponds to a select portion of a cavity, allowing the effects of the gate to be tuned. Such tuning of radial film gates can be more easily performed than tuning a relatively large number of edge gates. Annular ring gates typically comprise a substantially continuous gate surface, and any defect in an annular ring gate (e.g., from machining) typically requires that the entire gate be replaced (as opposed to just a portion). Adjustments to annular ring gate surfaces can also be difficult to see and/or measure.

These and other advantages of radial film gates can enlarge the so-called processing window allowing more complex parts and thinner layers to be injection molded. Typically, injection processes are adjusted to compensate for mold imperfections, giving a tool operator more latitude to compensate for variations outside his control, such as lot-to-lot variation of injection material viscosity. In addition, gate configuration can be tuned to control location and configuration of knit lines and the corresponding terminus of the flow path, providing better venting, lower variation and lower defect rates.

A more repeatable process allows core pins to remain holding the core in a centered position in the cavity for a longer duration before being retracted, providing a better centered core. These benefits can combine to provide golf balls with thinner layers (e.g., outer covers) from an injection-molded thermoplastic outer layer.

In addition, disclosed embodiments can be used in connection with a two-part catalyzing thermosetting polymer process, or reaction injection molding (RIM). For example, mold components can be added to enhance mixing of the polymer, such as an aftermixer or transducer.

### EXAMPLES

Benefits provided by a disclosed embodiment over a conventional mold configuration can be seen from the results of a simulation conducted using the commercially available Moldflow software. Simulations were run to compare the mold configuration shown in FIG. 3 to conventional mold configurations having 24 separate edge gates and 16 separate edge gates, respectively. All simulations assumed the injection material comprised the material characteristics of Surlyn® 8940 and simulated molding an outer layer of a golf ball having a maximum cover thickness of 0.030 inch.

The results of this comparison are summarized in Table 1, and show a substantial reduction in shear rate for radial film gates, as disclosed herein, relative to conventional edge gates. High shear rates can lead to material degradation and the evolution of gasses, which in turn can lead to gas entrapment and pronounced knit lines in a finished part. The considerable reduction in shear rate demonstrates but one advantage of the disclosed radial film gates over conventional gates.

TABLE 1

| | | | | Advantage of |
|---|---|---|---|---|
| | | | | Radial Film Gate |
| | 24 Edge | 16 Edge | Radial | Relative to 24 |
| Parameter | Gates | Gates | Film Gate | Edge Gates |
| Max. Injection | 78.76 | 84.95 | 68.71 | 14% Decrease |
| Pressure (Mpa) | | | | |
| Temperature at | 238 | 237 | 231 | 3% Decrease |
| Flow Front (° C.) | | | | |
| Shear Rate (l/s) | 46188 | 99538 | 12828 | 72% Decrease |

In one example, using an injection material having a melt flow index greater than or equal to 10, the injection molding methods described herein may be used to form an outer cover or intermediate layer having a maximum thickness less than about 0.045 inch, a minimum thickness at the dimples of less than about 0.030 inch, and/or a thickness range of about 0.025 to 0.045 inch.

In another example, using an injection material having a melt flow index less than 10, the injection molding methods described herein may be used to form an outer cover or intermediate layer having a maximum thickness less than about 0.055 inch, a minimum thickness at the dimples of less than about 0.040 inch, and/or a thickness range of about 0.025 to 0.055 inch.

It will be appreciated that while the methods described herein facilitate the formation of relatively thin polymer layers compared to conventional golf ball injection molding techniques, the disclosed methods offer other advantages independent of the thickness of the outer cover or intermediate layer(s). Stated differently, the described methods can be used to form an outer cover or intermediate layer having a thickness greater than, for example, about 0.045 inch or about 0.055 inch. For example, the methods described herein can be used to form a polymer layer in the range of about 0.010 to 0.100 inch, preferably 0.015 to 0.080 inch, more preferably 0.020 to 0.060 inch and most preferably the thickness ranges already described, it being appreciated that what is preferable may depend on the manufacturing, performance and cost objectives for the golf ball. Other advantages of the described methods include: 1) ease of processing and control; and 2) facilitating creation of a consistent and more uniform outer cover or layer.

### Injection Materials

Polymeric materials generally considered useful for making golf balls according to the process of the present invention may also be included in the components of the golf balls of the present invention and these include, without limitation, synthetic and natural rubbers, thermoset polymers such as other thermoset polyurethanes or thermoset polyureas, as well as thermoplastic polymers including thermoplastic elastomers such as metallocene catalyzed polymer, unimodal ethylene/carboxylic acid copolymers, unimodal ethylene/carboxylic acid/carboxylate terpolymers, bimodal ethylene/carboxylic acid copolymers, bimodal ethylene/carboxylic acid/carboxylate terpolymers, unimodal ionomers, bimodal ionomers, modified unimodal ionomers, modified bimodal ionomers, thermoplastic polyurethanes, thermoplastic polyureas, polyamides, copolyamides, polyesters, copolyesters, polycarbonates, polyolefins, halogenated (e.g. chlorinated) polyolefins, halogenated polyalkylene compounds, such as halogenated polyethylene [e.g. chlorinated polyethylene (CPE)], polyalkenamer, polyphenylene oxides, polyphenylene sulfides, diallyl phthalate polymers, polyimides, polyvinyl chlorides, polyamide-ionomers, polyurethane-ionomers, polyvinyl alcohols, polyarylates, polyacrylates, polyphenylene ethers, impact-modified polyphenylene ethers, polystyrenes, high impact polystyrenes, acrylonitrile-butadiene-styrene copolymers, styrene-acrylonitriles (SAN), acrylonitrile-styrene-acrylonitriles, styrene-maleic anhydride (S/MA) polymers, styrenic copolymers, functionalized styrenic copolymers, functionalized styrenic terpolymers, styrenic terpolymers, cellulosic polymers, liquid crystal polymers (LCP), ethylene-propylene-diene terpolymers (EPDM), ethylene-vinyl acetate copolymers (EVA), ethylene-propylene copolymers, ethylene vinyl acetates, polyureas, and polysiloxanes and any and all combinations thereof.

A most preferred polymeric material for golf balls is a polyurea or polyurethane, prepared by combining a diisocyanate with either a polyamine or polyol respectively, and one or more chain extenders (in the case of a thermoplastic polyurea or polyurethane) or curing agents (in the case of a thermoset polyurea or polyurethane) The final composition may advantageously be employed as an intermediate layer in a golf ball and even more advantageously as an outer cover layer.

Any isocyanate available to one of ordinary skill in the art is suitable for use according to the invention. Isocyanates for use with the present invention include, but are not limited to, aliphatic, cycloaliphatic, aromatic aliphatic, aromatic, any derivatives thereof, and combinations of these compounds having two or more isocyanate (NCO) groups per molecule. As used herein, aromatic aliphatic compounds should be understood as those containing an aromatic ring, wherein the isocyanate group is not directly bonded to the ring. One example of an aromatic aliphatic compound is a tetramethylene diisocyanate (TMXDI). The isocyanates may be organic polyisocyanate-terminated prepolymers, low free isocyanate prepolymer, and mixtures thereof. The isocyanate-containing reactable component may also include any isocyanate-functional monomer, dimer, trimer, or polymeric adduct thereof, prepolymer, quasi-prepolymer, or mixtures thereof. Isocyanate-functional compounds may include monoisocyanates or polyisocyanates that include any isocyanate functionality of two or more.

Suitable isocyanate-containing components include diisocyanates having the generic structure: O═C═N—R—N═C═O, where R is preferably a cyclic, aromatic, or linear or branched hydrocarbon moiety containing from about 1 to about 50 carbon atoms. The isocyanate may also contain one or more cyclic groups or one or more phenyl groups. When multiple cyclic or aromatic groups are present, linear and/or branched hydrocarbons containing from about 1 to about 10 carbon atoms can be present as spacers between the cyclic or aromatic groups. In some cases, the cyclic or aromatic group(s) may be substituted at the 2-, 3-, and/or 4-positions, or at the ortho-, meta-, and/or para- positions, respectively. Substituted groups may include, but are not limited to, halogens, primary, secondary, or tertiary hydrocarbon groups, or a mixture thereof.

Examples of isocyanates that can be used with the present invention include, but are not limited to, substituted and isomeric mixtures including 2,2′-, 2,4′-, and 4,4′-diphenylmethane diisocyanate (MDI); 3,3′-dimethyl-4,4′-biphenylene diisocyanate (TODI); toluene diisocyanate (TDI); polymeric MDI; carbodiimide-modified liquid 4,4′-diphenylmethane diisocyanate; para-phenylene diisocyanate (PPDI); meta-phenylene diisocyanate (MPDI); triphenyl methane-4,4′- and triphenyl methane-4,4″-triisocyanate; naphthylene-1,5-diisocyanate; 2,4′-, 4,4′-, and 2,2-biphenyl diisocyanate; polyphenylene polymethylene polyisocyanate (PMDI) (also known as polymeric PMDI); mixtures of MDI and PMDI; mixtures of PMDI and TDI; ethylene diisocyanate; propylene-1,2-diisocyanate; trimethylene diisocyanate; butylenes diisocyanate; bitolylene diisocyanate; tolidine diisocyanate; tetramethylene-1,2-diisocyanate; tetramethylene-1,3-diisocyanate; tetramethylene-1,4-diisocyanate; pentamethylene diisocyanate; 1,6-hexamethylene diisocyanate (HDI); octamethylene diisocyanate; decamethylene diisocyanate; 2,2,4-trimethylhexamethylene diisocyanate; 2,4,4-trimethylhexamethylene diisocyanate; dodecane-1,12-diisocyanate; dicyclohexylmethane diisocyanate; cyclobutane-1,3-diisocyanate; cyclohexane-1,2-diisocyanate; cyclohexane-1,3-diisocyanate; cyclohexane-1,4-diisocyanate; diethylidene diisocyanate; methylcyclohexylene diisocyanate (HTDI); 2,4-methylcyclohexane diisocyanate; 2,6-methylcyclohexane diisocyanate; 4,4′-dicyclohexyl diisocyanate; 2,4′-dicyclohexyl diisocyanate; 1,3,5-cyclohexane triisocyanate; isocyanatomethylcyclohexane isocyanate; 1-isocyanato-3,3,5-trimethyl-5-isocyanatomethylcyclohexane; isocyanatoethylcyclohexane isocyanate; bis(isocyanatomethyl)-cyclohexane diisocyanate; 4,4′-bis(isocyanatomethyl) dicyclohexane; 2,4′-bis(isocyanatomethyl) dicyclohexane; isophorone diisocyanate (IPDI); dimeryl diisocyanate, dodecane-1,12-diisocyanate, 1,10-decamethylene diisocyanate, cyclohexylene-1,2-diisocyanate, 1,10-decamethylene diisocyanate, 1-chlorobenzene-2,4-diisocyanate, furfurylidene diisocyanate, 2,4,4-trimethyl hexamethylene diisocyanate, 2,2,4-trimethyl hexamethylene diisocyanate, dodecamethylene diisocyanate, 1,3-cyclopentane diisocyanate, 1,3-cyclohexane diisocyanate, 1,3-cyclobutane diisocyanate, 1,4-cyclohexane diisocyanate, 4,4′-methylenebis(cyclohexyl isocyanate), 4,4′-methylenebis(phenyl isocyanate), 1-methyl-2,4-cyclohexane diisocyanate, 1-methyl-2,6-cyclohexane diisocyanate, 1,3-bis(isocyanato-methyl)cyclohexane, 1,6-diisocyanato-2,2,4,4-tetra-methylhexane, 1,6-diisocyanato-2,4,4-tetra-trimethylhexane, trans-cyclohexane-1,4-diisocyanate, 3-isocyanato-methyl-3,5,5-trimethylcyclo-hexyl isocyanate, 1-isocyanato-3,3,5-trimethyl-5-isocyanatomethylcyclohexane, cyclo-hexyl isocyanate, dicyclohexylmethane 4,4′-diisocyanate, 1,4-bis(isocyanatomethyl)cyclohexane, m-phenylene diisocyanate, m-xylylene diisocyanate, m-tetramethylxylylene diisocyanate, p-phenylene diisocyanate, p,p′-biphenyl diisocyanate, 3,3′-dimethyl-4,4′-biphenylene diisocyanate, 3,3′-dimethoxy-4,4′-biphenylene diisocyanate, 3,3′-diphenyl-4,4′-biphenylene diisocyanate, 4,4′-biphenylene diisocyanate, 3,3′-dichloro-4,4′-biphenylene diisocyanate, 1,5-naphthalene diisocyanate, 4-chloro-1,3-phenylene diisocyanate, 1,5-tetrahydronaphthalene diisocyanate, metaxylene diisocyanate, 2,4-toluene diisocyanate, 2,4′-diphenylmethane diisocyanate, 2,4-chlorophenylene diisocyanate, 4,4′-diphenylmethane diisocyanate, p,p′-diphenylmethane diisocyanate, 2,4-tolylene diisocyanate, 2,6-tolylene diisocyanate, 2,2-diphenylpropane-4,4′-diisocyanate, 4,4′-toluidine diisocyanate, dianidine diisocyanate, 4,4′-diphenyl ether diisocyanate, 1,3-xylylene diisocyanate, 1,4-naphthylene diisocyanate, azobenzene-4,4′-diisocyanate, diphenyl sulfone-4,4′-diisocyanate, triphenylmethane 4,4′,4″-triisocyanate, isocyanatoethyl methacrylate, 3-isopropenyl-α,α-dimethylbenzyl-isocyanate, dichlorohexamethylene diisocyanate, ω, ω′-diisocyanato-1,4-diethylbenzene, polymethylene polyphenylene polyisocyanate, isocyanurate modified compounds, and carbodiimide modified compounds, as well as biuret modified compounds of the above polyisocyanates. These isocyanates may be used either alone or in combination. These combination isocyanates include triisocyanates, such as biuret of hexamethylene diisocyanate and triphenylmethane triisocyanates, and polyisocyanates, such as polymeric diphenylmethane diisocyanate.triisocyanate of HDI; triisocyanate of 2,2,4-trimethyl-1,6-hexane diisocyanate (TMDI); 4,4′-dicyclohexylmethane diisocyanate (H₁₂MDI); 2,4-hexahydrotoluene diisocyanate; 2,6-hexahydrotoluene diisocyanate; 1,2-, 1,3-, and 1,4-phenylene diisocyanate; aromatic aliphatic isocyanate, such as 1,2-, 1,3-, and 1,4-xylene diisocyanate; meta-tetramethylxylene diisocyanate (m-TMXDI); para-tetramethylxylene diisocyanate (p-TMXDI); trimerized isocyanurate of any polyisocyanate, such as isocyanurate of toluene diisocyanate, trimer of diphenylmethane diisocyanate, trimer of tetramethylxylene diisocyanate, isocyanurate of hexamethylene diisocyanate, and mixtures thereof, dimerized uretdione of any polyisocyanate, such as uretdione of toluene diisocyanate, uretdione of hexamethylene diisocyanate, and mixtures thereof; modified polyisocyanate derived from the above isocyanates and polyisocyanates; and mixtures thereof.

Any polyol available to one of ordinary skill in the polyurethane art is suitable for use according to the invention. Polyols suitable for use in the reduced-yellowing compositions of the present invention include, but are not limited to, polyester polyols, polyether polyols, polycarbonate polyols and polydiene polyols such as polybutadiene polyols.

Polyester polyols are prepared by condensation or step-growth polymerization utilizing diacids. Primary diacids for polyester polyols are adipic acid and isomeric phthalic acids. Adipic acid is used for materials requiring added flexibility, whereas phthalic anhydride is used for those requiring rigidity. Some examples of polyester polyols include poly(ethylene adipate) (PEA), poly(diethylene adipate) (PDA), poly(propylene adipate) (PPA), poly(tetramethylene adipate) (PBA), poly(hexamethylene adipate) (PHA), poly(neopentylene adipate) (PNA), polyols composed of 3-methyl-1,5-pentanediol and adipic acid, random copolymer of PEA and PDA, random copolymer of PEA and PPA, random copolymer of PEA and PBA, random copolymer of PHA and PNA, caprolactone polyol obtained by the ring-opening polymerization of ε-caprolactone, and polyol obtained by opening the ring of β-methyl-δ-valerolactone with ethylene glycol can be used either alone or in a combination thereof. Additionally, polyester polyol may be composed of a copolymer of at least one of the following acids and at least one of the following glycols. The acids include terephthalic acid, isophthalic acid, phthalic anhydride, oxalic acid, malonic acid, succinic acid, pentanedioic acid, hexanedioic acid, octanedioic acid, nonanedioic acid, adipic acid, azelaic acid, sebacic acid, dodecanedioic acid, dimer acid (a mixture), ρ-hydroxybenzoate, trimellitic anhydride, ε-caprolactone, and β-methyl-δ-valerolactone. The glycols includes ethylene glycol, propylene glycol, butylene glycol, pentylene glycol, 1,4-butanediol, 1,5-pentanediol, 1,6-hexanediol, neopentylene glycol, polyethylene glycol, polytetramethylene glycol, 1,4-cyclohexane dimethanol, pentaerythritol, and 3-methyl-1,5-pentanediol.

Polyether polyols are prepared by the ring-opening addition polymerization of an alkylene oxide (e.g. ethylene oxide and propylene oxide) with an initiator of a polyhydric alcohol (e.g. diethylene glycol), which is an active hydride. Specifically, polypropylene glycol (PPG), polyethylene glycol (PEG) or propylene oxide-ethylene oxide copolymer can be obtained. Polytetramethylene ether glycol (PTMG) is prepared by the ring-opening polymerization of tetrahydrofuran, produced by dehydration of 1,4-butanediol or hydrogenation of furan. Tetrahydrofuran can form a copolymer with alkylene oxide. Specifically, tetrahydrofuran-propylene oxide copolymer or tetrahydrofuran-ethylene oxide copolymer can be formed. The polyether polyol may be used either alone or in a combination.

Polycarbonate polyol is obtained by the condensation of a known polyol (polyhydric alcohol) with phosgene, chloroformic acid ester, dialkyl carbonate or diallyl carbonate. Particularly preferred polycarbonate polyol contains a polyol component using 1,6-hexanediol, 1,4-butanediol, 1,3-butanediol, neopentylglycol or 1,5-pentanediol. Polycarbonate polyols can be used either alone or in a combination with other polyols.

Polydiene polyol includes liquid diene polymer containing hydroxyl groups having an average of at least 1.7 functional groups, and may be composed of diene polymer or diene copolymer having 4 to 12 carbon atoms, or a copolymer of such diene with addition to polymerizable α-olefin monomer having 2 to 2.2 carbon atoms. Specific examples include butadiene homopolymer, isoprene homopolymer, butadiene-styrene copolymer, butadiene-isoprene copolymer, butadiene-acrylonitrile copolymer, butadiene-2-ethyl hexyl acrylate copolymer, and butadiene-n-octadecyl acrylate copolymer. These liquid diene polymers can be obtained, for example, by heating a conjugated diene monomer in the presence of hydrogen peroxide in a liquid reactant.

Polybutadiene polyol includes liquid diene polymer containing hydroxyl groups having an average of at least 1.7 functional groups, and may be composed of diene polymer or diene copolymer having 4 to 12 carbon atoms, or a copolymer of such diene with addition to polymerizable α-olefin monomer having 2 to 2.2 carbon atoms. Specific examples include butadiene homopolymer, isoprene homopolymer, butadiene-styrene copolymer, butadiene-isoprene copolymer, butadiene-acrylonitrile copolymer, butadiene-2-ethyl hexyl acrylate copolymer, and butadiene-n-octadecyl acrylate copolymer. These liquid diene polymers can be obtained, for example, by heating a conjugated diene monomer in the presence of hydrogen peroxide in a liquid reactant

Any polyamine available to one of ordinary skill in the polyurethane art is suitable for use according to the invention. Polyamines suitable for use in the reduced-yellowing compositions of the present invention include, but are not limited to, The amine-terminated compound is selected from the group consisting of amine-terminated hydrocarbons, amine-terminated polyethers, amine-terminated polyesters, amine-terminated polycaprolactones, amine-terminated polycarbonates, amine-terminated polyamides, and mixtures thereof. The amine-terminated compound may be a polyether amine selected from the group consisting of polytetramethylene ether diamines, polyoxypropylene diamines, poly(ethylene oxide capped oxypropylene) ether diamines, triethyleneglycoldiamines, propylene oxide-based triamines, trimethylolpropane-based triamines, glycerin-based triamines, and mixtures thereof.

The previously described diisocyante and polyol or polyamine components may be previously combined to form a prepolymer prior to reaction with the chain extender or curing agent. Any such prepolymer combination is suitable for use in the present invention. Commercially available prepolymers include LFH580, LFH120, LFH710, LFH1570, LF930A, LF950A, LF601D, LF751D, LFG963A, LFG640D.

One preferred prepolymer is a toluene diisocyanate prepolymer with polypropylene glycol. Such polypropylene glycol terminated toluene diisocyanate prepolymers are available from Uniroyal Chemical Company of Middlebury, Conn., under the trade name ADIPRENE® LFG963A and LFG640D. Most preferred prepolymers are the polytetramethylene ether glycol terminated toluene diisocyanate prepolymers including those available from Uniroyal Chemical Company of Middlebury, Conn., under the trade name ADIPRENE® LF930A, LF950A, LF601D, and LF751D.

In one embodiment, the number of free NCO groups in the urethane or urea prepolymer may be less than about 14 percent. Preferably the urethane or urea prepolymer has from about 3 percent to about 11 percent, more preferably from about 4 to about 9.5 percent and even more preferably from about 3 percent to about 9 percent free NCO on an equivalent weight basis.

In view of the aforementioned advantages of injection molding versus the more complex casting process, under some circumstances it is advantageous to have formulations which are able to cure as a thermoset but only within a specified temperature range which is above that of the typical injection molding process. This allows parts, such as golf ball cover layers, to be initially injection molded, followed by subsequent processing at higher temperatures and pressures to induce further crosslinking and curing, resulting in thermoset properties in the final part. Such an initially injection moldable composition is thus called a post curable urethane or urea composition. Post curable urethane and urea compositions are examples of post curable resins which work well with the disclosed process.

If a post curable polyurea or polyurethane composition is required, a modified or blocked diisocyanate which subsequently unblocks and induces further cross linking post extrusion may be included in the diisocyanate starting material. Such a system is disclosed by Kim et al in U.S. Pat. No. 6,939,924, the entire contents of which are hereby incorporated by reference. Alternatively, a thermoplastic urethane or urea composition further comprising a peroxide or peroxide mixture, can then under post curing to result in a thermoset. Such a system is disclosed by Kim in U.S. Pat. No. 6,924,337, the entire contents of which are hereby incorporated by reference. Finally the thermoplastic urethane or urea compositions may further comprising a reaction product of a nitroso compound and a diisocyanate or a polyisocyanate to induce further cross linking post extrusion may be included in the diisocyanate starting material Such a system is disclosed by Kim et al in U.S. Pat. No. 7,037,985 B2, the entire contents of which are hereby incorporated by reference.

Because the polyureas or polyurethanes used to make the covers of such golf balls generally contain an aromatic component, e.g., aromatic diisocyanate, polyol, or polyamine, they are susceptible to discoloration upon exposure to light, particularly ultraviolet (UV) light. To slow down the discoloration, light and UV stabilizers, e.g., TINUVIN® 770, 765, and 328, are added to these aromatic polymeric materials.

In addition, non-aromatic components may be used to minimize this discoloration, one example of which is described in copending U.S. patent application Ser. No. 11/809,432, filed on May 31, 2007, the entire contents of which are hereby incorporated by reference.

The outer cover and/or one or intermediate layers of the golf ball may also comprise one or more ionomer resins. One family of such resins was developed in the mid-1960's, by E.I. DuPont de Nemours and Co., and sold under the trademark SURLYN®. Preparation of such ionomers is well known, for example see U.S. Pat. No. 3,264,272. Generally speaking, most commercial ionomers are unimodal and consist of a polymer of a mono-olefin, e.g., an alkene, with an unsaturated mono- or dicarboxylic acids having 3 to 12 carbon atoms. An additional monomer in the form of a mono- or dicarboxylic acid ester may also be incorporated in the formulation as a so-called “softening comonomer.” The incorporated carboxylic acid groups are then neutralized by a basic metal ion salt, to form the ionomer. The metal cations of the basic metal ion salt used for neutralization include Li⁺, Na⁺, K⁺, Zn²⁺, Ca²⁺, Co²⁺, Ni²⁺, Cu²⁺, Pb²⁺, and Mg²⁺, with the Li⁺, Na⁺, Ca²⁺, Zn²⁺, and Mg²⁺ being preferred. The basic metal ion salts include those of for example formic acid, acetic acid, nitric acid, and carbonic acid, hydrogen carbonate salts, oxides, hydroxides, and alkoxides.

The first commercially available ionomer resins contained up to 16 weight percent acrylic or methacrylic acid, although it was also well known at that time that, as a general rule, the hardness of these cover materials could be increased with increasing acid content. Hence, in Research Disclosure 29703, published in January 1989, DuPont disclosed ionomers based on ethylene/acrylic acid or ethylene/methacrylic acid containing acid contents of greater than 15 weight percent. In this same disclosure, DuPont also taught that such so called “high acid ionomers” had significantly improved stiffness and hardness and thus could be advantageously used in golf ball construction, when used either singly or in a blend with other ionomers.

More recently, high acid ionomers can be ionomer resins with acrylic or methacrylic acid units present from 16 wt. % to about 35 wt. % in the polymer. Generally, such a high acid ionomer will have a flexural modulus from about 50,000 psi to about 125,000 psi.

Ionomer resins further comprising a softening comonomer, present from about 10 wt. % to about 50 wt. % in the polymer, have a flexural modulus from about 2,000 psi to about 10,000 psi, and are sometimes referred to as “soft” or “very low modulus” ionomers. Typical softening comonomers include n-butyl acrylate, iso-butyl acrylate, n-butyl methacrylate, methyl acrylate and methyl methacrylate.

Today, there are a wide variety of commercially available ionomer resins based both on copolymers of ethylene and (meth)acrylic acid or terpolymers of ethylene and (meth)acrylic acid and (meth)acrylate, all of which many of which are be used as a golf ball component. The properties of these ionomer resins can vary widely due to variations in acid content, softening comonomer content, the degree of neutralization, and the type of metal ion used in the neutralization. The full range commercially available typically includes ionomers of polymers of general formula, E/X/Y polymer, wherein E is ethylene, X is a C₃ to C₈ α,β ethylenically unsaturated carboxylic acid, such as acrylic or methacrylic acid, and is present in an amount from about 2 to about 30 weight % of the E/X/Y copolymer, and Y is a softening comonomer selected from the group consisting of alkyl acrylate and alkyl methacrylate, such as methyl acrylate or methyl methacrylate, and wherein the alkyl groups have from 1-8 carbon atoms, Y is in the range of 0 to about 50 weight % of the E/X/Y copolymer, and wherein the acid groups present in said ionomeric polymer are partially neutralized with a metal selected from the group consisting of lithium, sodium, potassium, magnesium, calcium, barium, lead, tin, zinc or aluminum, and combinations thereof.

The ionomer may also be a so-called bimodal ionomer as described in U.S. Pat. No. 6,562,906 (the entire contents of which are herein incorporated by reference). These ionomers are bimodal as they are prepared from blends comprising polymers of different molecular weights. Specifically they include bimodal polymer blend compositions comprising:
a) a high molecular weight component having a weight average molecular weight, Mw, of about 80,000 to about 500,000 and comprising one or more ethylene/α, β-ethylenically unsaturated C₃₋₈ carboxylic acid copolymers and/or one or more ethylene, alkyl (meth)acrylate, (meth)acrylic acid terpolymers; said high molecular weight component being partially neutralized with metal ions selected from the group consisting of lithium, sodium, zinc, calcium, magnesium, and a mixture of any these; and
b) a low molecular weight component having a weight average molecular weight, Mw, of from about 2,000 to about 30,000 and comprising one or more ethylene/α, β-ethylenically unsaturated C₃₋₈ carboxylic acid copolymers and/or one or more ethylene, alkyl (meth)acrylate, (meth)acrylic acid terpolymers; said low molecular weight component being partially neutralized with metal ions selected from the group consisting of lithium, sodium, potassium, magnesium, calcium, barium, lead, tin, zinc or aluminum, and a mixture of any these.

In addition to the unimodal and bimodal ionomers, also included are the so-called “modified ionomers” examples of which are described in U.S. Pat. Nos. 6,100,321, 6,329,458 and 6,616,552 and U.S. Patent Publication No. US 2003/0158312 A1, the entire contents of all of which are herein incorporated by reference.

The modified unimodal ionomers may be prepared by mixing:
a) an ionomeric polymer comprising ethylene, from 5 to 25 weight percent (meth)acrylic acid, and from 0 to 40 weight percent of a (meth)acrylate monomer, said ionomeric polymer neutralized with metal ions selected from the group consisting of lithium, sodium, potassium, magnesium, calcium, barium, lead, tin, zinc or aluminum, and any and all mixtures thereof; and
b) from about 5 to about 40 weight percent (based on the total weight of said modified ionomeric polymer) of one or more fatty acids or metal salts of said fatty acid, the metal selected from the group consisting of lithium, sodium, potassium, magnesium, calcium, barium, lead, tin, zinc or aluminum, and any and all mixtures thereof; and the fatty acid preferably being stearic acid.

The modified bimodal ionomers, which are ionomers derived from the earlier described bimodal ethylene/carboxylic acid polymers (as described in U.S. Pat. No. 6,562,906, the entire contents of which are herein incorporated by reference), are prepared by mixing;
a) a high molecular weight component having a weight average molecular weight, Mw, of about 80,000 to about 500,000 and comprising one or more ethylene/α, β-ethylenically unsaturated C₃₋₈ carboxylic acid copolymers and/or one or more ethylene, alkyl (meth)acrylate, (meth)acrylic acid terpolymers; said high molecular weight component being partially neutralized with metal ions selected from the group consisting of lithium, sodium, potassium, magnesium, calcium, barium, lead, tin, zinc or aluminum, and any and all mixtures thereof; and
b) a low molecular weight component having a weight average molecular weight, Mw, of from about 2,000 to about 30,000 and comprising one or more ethylene/α, β-ethylenically unsaturated C₃₋₈ carboxylic acid copolymers and/or one or more ethylene, alkyl (meth)acrylate, (meth)acrylic acid terpolymers; said low molecular weight component being partially neutralized with metal ions selected from the group consisting of lithium, sodium, potassium, magnesium, calcium, barium, lead, tin, zinc or aluminum, and any and all mixtures thereof; and
c) from about 5 to about 40 weight percent (based on the total weight of said modified ionomeric polymer) of one or more fatty acids or metal salts of said fatty acid, the metal selected from the group consisting of lithium, sodium, potassium, magnesium, calcium, barium, lead, tin, zinc or aluminum, and any and all mixtures thereof; and the fatty acid preferably being stearic acid.

The fatty or waxy acid salts utilized in the various modified ionomers are composed of a chain of alkyl groups containing from about 4 to 75 carbon atoms (usually even numbered) and characterized by a —COOH terminal group. The generic formula for all fatty and waxy acids above acetic acid is CH₃ (CH₂)_{X}COOH, wherein the carbon atom count includes the carboxyl group (i.e. x=2-73). The fatty or waxy acids utilized to produce the fatty or waxy acid salts modifiers may be saturated or unsaturated, and they may be present in solid, semi-solid or liquid form.

Examples of suitable saturated fatty acids, i.e., fatty acids in which the carbon atoms of the alkyl chain are connected by single bonds, include but are not limited to stearic acid (C₁₈, i.e., CH₃ (CH₂)₁₆COOH), palmitic acid (C₁₆, i.e., CH₃ (CH₂)₁₄COOH), pelargonic acid (C₉, i.e., CH₃ (CH₂)₇COOH) and lauric acid (C₁₂, i.e., CH₃ (CH₂)₁₀OCOOH). Examples of suitable unsaturated fatty acids, i.e., a fatty acid in which there are one or more double bonds between the carbon atoms in the alkyl chain, include but are not limited to oleic acid (C₁₃, i.e., CH₃ (CH₂)₇CH:CH(CH₂)₇COOH).

The source of the metal ions used to produce the metal salts of the fatty or waxy acid salts used in the various modified ionomers are generally various metal salts which provide the metal ions capable of neutralizing, to various extents, the carboxylic acid groups of the fatty acids. These include the sulfate, carbonate, acetate and hydroxylate salts of zinc, barium, calcium and magnesium.

Since the fatty acid salts modifiers comprise various combinations of fatty acids neutralized with a large number of different metal ions, several different types of fatty acid salts may be utilized in the invention, including metal stearates, laureates, oleates, and palmitates, with calcium, zinc, sodium, lithium, potassium and magnesium stearate being preferred, and calcium and sodium stearate being most preferred.

The fatty or waxy acid or metal salt of said fatty or waxy acid is present in the modified ionomeric polymers in an amount of from about 5 to about 40, preferably from about 7 to about 35, more preferably from about 8 to about 20 weight percent (based on the total weight of said modified ionomeric polymer).

As a result of the addition of the one or more metal salts of a fatty or waxy acid, from about 40 to 100, preferably from about 50 to 100, more preferably from about 70 to 100 percent of the acidic groups in the final modified ionomeric polymer composition are neutralized by a metal ion. An example of such a modified ionomer polymer is DuPont® HPF-1000 available from E. I. DuPont de Nemours and Co. Inc.

A preferred ionomer composition may be prepared by blending one or more of the unimodal ionomers, bimodal ionomers, or modified unimodal or bimodal ionomeric polymers as described herein, and further blended with a zinc neutralized ionomer of a polymer of general formula E/X/Y where E is ethylene, X is a softening comonomer such as acrylate or methacrylate and is present in an amount of from 0 to about 50, preferably 0 to about 25, most preferably 0, and Y is acrylic or methacrylic acid and is present in an amount from about 5 wt. % to about 25, preferably from about 10 to about 25, and most preferably about 10 to about 20 wt % of the total composition.

The outer cover and/or one or intermediate layers of the golf ball may also comprise one or more polyamide resins. Illustrative polyamides for use in the golf balls disclosed include those obtained by: (1) polycondensation of (a) a dicarboxylic acid, such as oxalic acid, adipic acid, sebacic acid, terephthalic acid, isophthalic acid, or 1,4-cyclohexanedicarboxylic acid, with (b) a diamine, such as ethylenediamine, tetramethylenediamine, pentamethylenediamine, hexamethylenediamine, decamethylenediamine, 1,4-cyclohexyldiamine or m-xylylenediamine; (2) a ring-opening polymerization of cyclic lactam, such as ε-caprolactam or ω-laurolactam; (3) polycondensation of an aminocarboxylic acid, such as 6-aminocaproic acid, 9-aminononanoic acid, 11-aminoundecanoic acid or 12-aminododecanoic acid; (4) copolymerization of a cyclic lactam with a dicarboxylic acid and a diamine; or any combination of (1)-(4). In certain examples, the dicarboxylic acid may be an aromatic dicarboxylic acid or a cycloaliphatic dicarboxylic acid. In certain examples, the diamine may be an aromatic diamine or a cycloaliphatic diamine. Specific examples of suitable polyamides include polyamide 6; polyamide 11; polyamide 12; polyamide 4,6; polyamide 6,6; polyamide 6,9; polyamide 6,10; polyamide 6,12; polyamide MXD6; PA12,CX; PA12, IT; PPA; PA6, IT; and PA6/PPE.

The polyamide may be any homopolyamide or copolyamide. One example of a group of suitable polyamides is thermoplastic polyamide elastomers. Thermoplastic polyamide elastomers typically are copolymers of a polyamide and polyester or polyether. For example, the thermoplastic polyamide elastomer can contain a polyamide (Nylon 6, Nylon 66, Nylon 11, Nylon 12 and the like) as a hard segment and a polyether or polyester as a soft segment. In one specific example, the thermoplastic polyamides are amorphous copolyamides based on polyamide (PA 12).

Examples of copolyester thermoplastic elastomers include polyether ester block copolymers, polylactone ester block copolymers, and aliphatic and aromatic dicarboxylic acid copolymerized polyesters. Polyether ester block copolymers are copolymers comprising polyester hard segments polymerized from a dicarboxylic acid and a low molecular weight diol, and polyether soft segments polymerized from an alkylene glycol having 2 to 10 atoms. Polylactone ester block copolymers are copolymers having polylactone chains instead of polyether as the soft segments discussed above for polyether ester block copolymers. Aliphatic and aromatic dicarboxylic copolymerized polyesters are copolymers of an acid component selected from aromatic dicarboxylic acids, such as terephthalic acid and isophthalic acid, and aliphatic acids having 2 to 10 carbon atoms with at least one diol component, selected from aliphatic and alicyclic diols having 2 to 10 carbon atoms. Blends of aromatic polyester and aliphatic polyester also may be used for these. Examples of these include products marketed under the trade names HYTREL by E.I. DuPont de Nemours & Company, and SKYPEL by S.K. Chemicals The polyether block comprises different units such as units which derive from ethylene glycol, propylene glycol, or tetramethylene glycol.

One type of polyetherester elastomer is the family of Pebax, which are available from Elf-Atochem Company. Preferably, the choice can be made from among Pebax 2533, 3533, 4033, 1205, 7033 and 7233. Some examples of suitable polyamides for use include those commercially available under the trade names PEBAX, CRISTAMID and RILSAN marketed by Atofina Chemicals of Philadelphia, Pa., GRIVORY and GRILAMID marketed by EMS Chemie of Sumter, S.C., TROGAMID and VESTAMID available from Degussa, and ZYTEL marketed by E.I. DuPont de Nemours & Co., of Wilmington, Del.

The outer cover and/or one or intermediate layers of the golf ball may also comprise a blend of an ionomer and a block copolymer. Examples of such block copolymers include styrenic block copolymers including styrene-butadiene-styrene (SBS), styrene-ethylene-butylene-styrene, (SEBS) and styrene-ethylene/propylene-styrene (SEPS). Also included are functionalized styrenic block copolymers, including those where the block copolymer incorporates a first polymer block having an aromatic vinyl compound, a second polymer block having a conjugated diene compound and a hydroxyl group located at a block copolymer, or its hydrogenation product, and in which the ratio of block copolymer to ionomer ranges from 5:95 to 95:5 by weight, more preferably from about 10:90 to about 90:10 by weight, more preferably from about 20:80 to about 80:20 by weight, more preferably from about 30:70 to about 70:30 by weight and most preferably from about 35:65 to about 65:35 by weight. A preferred functionalized styrenic block copolymer is SEPTON HG-252. Such blends are described in more detail in commonly-assigned U.S. Pat. No. 6,861,474 and U.S. Patent Publication No. 2003/0224871 both of which are incorporated herein by reference in their entireties.

More preferred blends of block copolymers include from about 85 to about 99 wt % (based on the combined weight of Components A and B) of a block copolymer; and (B) from about 1 to about 15 wt % (based on the combined weight of Components A and B) of one or more modifying agents selected from the group consisting of amino acids, aminotriazines, dicyandiamides and polyamines and any and all combinations thereof.

Another preferred material for the outer cover and/or one or intermediate layers of the golf ball is a composition prepared by blending together at least three materials, identified as Components A, B, and C, and melt-processing these components to form in-situ, a polymer blend composition incorporating a pseudo-crosslinked polymer network. Such blends are described in more detail in commonly-assigned U.S. Pat. No. 6,930,150, to Kim et al, the content of which is incorporated by reference herein in its entirety. Component A is a monomer, oligomer, prepolymer or polymer that incorporates at least five percent by weight of at least one type of an acidic functional group. Examples of such polymers suitable for use as include, but are not limited to, ethylene/(meth)acrylic acid copolymers and ethylene/(meth)acrylic acid/alkyl (meth)acrylate terpolymers, or ethylene and/or propylene maleic anhydride copolymers and terpolymers. Examples of such polymers which are commercially available include, but are not limited to, the Escor® 5000, 5001, 5020, 5050, 5070, 5100, 5110 and 5200 series of ethylene-acrylic acid copolymers sold by Exxon and the PRIMACOR® 1321, 1410, 1410-XT, 1420, 1430, 2912, 3150, 3330, 3340, 3440, 3460, 4311, 4608 and 5980 series of ethylene-acrylic acid copolymers sold by The Dow Chemical Company, Midland, Mich. and the ethylene-acrylic acid copolymers Nucrel 599, 699, 0903, 0910, 925, 960, 2806, and 2906 ethylene-methacrylic acid copolymers. sold by DuPont Also included are the bimodal ethylene/carboxylic acid polymers as described in U.S. Pat. No. 6,562,906, the contents of which are incorporated herein by reference. These polymers comprise ethylene/α, β-ethylenically unsaturated C₃₋₈ carboxylic acid high copolymers, particularly ethylene (meth)acrylic acid copolymers and ethylene, alkyl (meth)acrylate, (meth)acrylic acid terpolymers, having molecular weights of about 80,000 to about 500,000 which are melt blended with ethylene/α, β-ethylenically unsaturated C₃₋₈ carboxylic acid copolymers, particularly ethylene/(meth)acrylic acid copolymers having molecular weights of about 2,000 to about 30,000.

Component B can be any monomer, oligomer, or polymer, preferably having a lower weight percentage of anionic functional groups than that present in Component A in the weight ranges discussed above, and most preferably free of such functional groups.

Examples of materials for use as Component B include block copolymers such as styrenic block copolymers including styrene-butadiene-styrene (SBS), styrene-ethylene-butylene-styrene, (SEBS) and styrene-ethylene/propylene-styrene (SEPS). Also included are functionalized styrenic block copolymers, including those where the block copolymer incorporates a first polymer block having an aromatic vinyl compound, a second polymer block having a conjugated diene compound and a hydroxyl group located at a block copolymer, or its hydrogenation product. Commercial examples SEPTON marketed by Kuraray Company of Kurashiki, Japan; TOPRENE by Kumho Petrochemical Co., Ltd and KRATON marketed by Kraton Polymers.

Component C is a base capable of neutralizing the acidic functional group of Component A and is a base having a metal cation. These metals are from groups IA, IB, IIA, IIB, IIIA, IIIB, IVA, IVB, VA, VB, VIIA, VIIB, VIIB and VIIIB of the periodic table. Examples of these metals include lithium, sodium, magnesium, aluminum, potassium, calcium, manganese, tungsten, titanium, iron, cobalt, nickel, hafnium, copper, zinc, barium, zirconium, and tin. Suitable metal compounds for use as a source of Component C are, for example, metal salts, preferably metal hydroxides, metal oxides, metal carbonates, or metal acetates.

The composition preferably is prepared by mixing the above materials into each other thoroughly, either by using a dispersive mixing mechanism, a distributive mixing mechanism, or a combination of these. These mixing methods are well known in the manufacture of polymer blends. As a result of this mixing, the anionic functional group of Component A is dispersed evenly throughout the mixture. Most preferably, Components A and B are melt-mixed together without Component C, with or without the premixing discussed above, to produce a melt-mixture of the two components. Then, Component C separately is mixed into the blend of Components A and B. This mixture is melt-mixed to produce the reaction product. This two-step mixing can be performed in a single process, such as, for example, an extrusion process using a proper barrel length or screw configuration, along with a multiple feeding system.

The outer cover and/or one or intermediate layers of the golf ball may also comprise one or more polyalkenamers which may be prepared by ring opening metathesis polymerization of one or more cycloalkenes in the presence of organometallic catalysts as described in U.S. Pat. Nos. 3,492,245 and 3,804,803, the entire contents of both of which are herein incorporated by reference. Examples of suitable polyalkenamer rubbers are polypentenamer rubber, polyheptenamer rubber, polyoctenamer rubber, polydecenamer rubber and polydodecenamer rubber. For further details concerning polyalkenamer rubber, see Rubber Chem. & Tech., Vol. 47, page 511-596, 1974, which is incorporated herein by reference. Polyoctenamer rubbers are commercially available from Huls AG of Marl, Germany, and through its distributor in the U.S., Creanova Inc. of Somerset, N.J., and sold under the trademark VESTENAMER®. Two grades of the VESTENAMER® trans-polyoctenamer are commercially available: VESTENAMER 8012 designates a material having a trans-content of approximately 80% (and a cis- content of 20%) with a melting point of approximately 54° C.; and VESTENAMER 6213 designates a material having a trans-content of approximately 60% (cis- content of 40%) with a melting point of approximately 30° C. Both of these polymers have a double bond at every eighth carbon atom in the ring.

The polyalkenamer rubbers used in the present invention exhibit excellent melt processability above their sharp melting temperatures and exhibit high miscibility with various rubber additives as a major component without deterioration of crystallinity which in turn facilitates injection molding. Thus, unlike synthetic rubbers typically used in golf ball preparation, polyalkenamer-based compounds can be prepared which, are injection moldable. The polyalkenamer rubbers may also be blended within other polymers and an especially preferred blend is that of a polyalkenamer and a polyamide. A more complete description of the polyalkenamer rubbers and blends with polyamides is disclosed in copending U.S. application Ser. No. 11/335,070, filed on Jan. 18, 2006, in the name of Hyun Kim et al., the entire contents of which are hereby incorporated by reference

### DEFINITIONS

As used herein, the singular forms “a,” “an,” and “the” include the corresponding plural forms unless the context clearly dictates otherwise. Additionally, the term “includes” means “comprises.” Further, the term “coupled” encompasses any of various ways in which one thing is linked, mounted, or attached to, and does not exclude the presence of intermediate elements between the coupled things.

Certain terms may be used such as “up,” “down,”, “upper,” “lower,” “horizontal,” “vertical,” “left,” “right,” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object.

As used herein, “radial film gate” means an injection molding flow feature providing a generally radial flow channel relative to a cavity and defining an opening with a width oriented in a substantially common plane with a circumference or perimeter of the cavity, and a width-to-thickness ratio of at least about 4:1. A radial film gate has a width less than about one-half of a corresponding cavity's circumference. In contrast to a radial film gate, an annular film gate extends around substantially the entire circumference or perimeter. In some embodiments, radial film gates are no thicker than about 0.060 inch. The term “(meth)acrylic acid copolymers” is intended to mean copolymers of methacrylic acid and/or acrylic acid.

The term “(meth)acrylate” is intended to mean an ester of methacrylic acid and/or acrylic acid.

The term “partially neutralized” is intended to mean an ionomer with a degree of neutralization of less than 100 percent.

The term “hydrocarbyl” is intended to mean any aliphatic, cycloaliphatic, aromatic, aryl substituted aliphatic, aryl substituted cycloaliphatic, aliphatic substituted aromatic, or cycloaliphatic substituted aromatic groups. The aliphatic or cycloaliphatic groups are preferably saturated. Likewise, the term “hydrocarbyloxy” means a hydrocarbyl group having an oxygen linkage between it and the carbon atom to which it is attached.

As used herein, the term “core” is intended to mean the elastic center of a golf ball. The core may have one or more “core layers” of elastic material, which are usually made of rubbery material such as diene rubbers.

The term “cover layer” is intended to mean the outermost layer of the golf ball; this is the layer that is directly in contact with paint and/or ink on the surface of the golf ball. If the cover consists of two or more layers, only the outermost layer is designated the cover layer, and the remaining layers (excluding the outermost layer) are commonly designated intermediate layers as herein defined. The term “outer cover layer” as used herein is used interchangeably with the term “cover layer.”

The term “intermediate layer” may be used interchangeably herein with the terms “mantle layer” or “inner cover layer” and is intended to mean any layer(s) in a golf ball disposed between the core and the outer cover layer. Should a ball have more than one intermediate layer, these may be distinguished as “inner intermediate” or “inner mantle” layers which are used interchangeably to refer to the intermediate layer nearer the core and further from the outer cover, as opposed to the “outer intermediate” or “outer mantle layer” which are also used interchangeably to refer to the intermediate layer further from the core and closer to the outer cover.

The term “prepolymer” as used herein is intended to mean any material that can be further processed to form a final polymer material of a manufactured golf ball, such as, by way of example and not limitation, a polymerized or partially polymerized material that can undergo additional processing, such as crosslinking.

A “thermoplastic” as used herein is intended to mean a material that is capable of softening or melting when heated and of hardening again when cooled. Thermoplastic polymer chains often are not cross-linked or are lightly crosslinked using a chain extender, but the term “thermoplastic” as used herein may refer to materials that initially act as thermoplastics, such as during an initial extrusion process or injection molding process, but which also may be crosslinked, such as during a compression molding step to form a final structure.

A “thermoset” as used herein is intended to mean a material that crosslinks or cures via interaction with as crosslinking or curing agent. Crosslinking may be induced by energy, such as heat (generally above 200° C.), through a chemical reaction (by reaction with a curing agent), or by irradiation. The resulting composition remains rigid when set, and does not soften with heating. Thermosets have this property because the long-chain polymer molecules cross-link with each other to give a rigid structure. A thermoset material cannot be melted and re-molded after it is cured. Thus thermosets do not lend themselves to recycling unlike thermoplastics, which can be melted and re-molded.

The term “thermoplastic polyurethane” as used herein is intended to mean a material prepared by reaction of a prepared by reaction of a diisocyanate with a polyol, and optionally addition of a chain extender.

The term “thermoplastic polyurea” as used herein is intended to mean a material prepared by reaction of a prepared by reaction of a diisocyanate with a polyamine, with optionally addition of a chain extender.

The term “thermoset polyurethane” as used herein is intended to mean a material prepared by reaction of a diisocyanate with a polyol, and a curing agent.

The term “thermoset polyurea” as used herein is intended to mean a material prepared by reaction of a diisocyanate with a polyamine, and a curing agent.

A “urethane prepolymer” as used herein is intended to mean the reaction product of diisocyanate and a polyol.

A “urea prepolymer” as used herein is intended to mean the reaction product of a diisocyanate and a polyamine.

The term “zwitterion” as used herein is intended to mean a form of the compound having both an amine group and carboxylic acid group, Component (B), where both are charged and where the net charge on the compound is neutral.

The term “bimodal polymer” refers to a polymer comprising two main fractions and more specifically to the form of the polymers molecular weight distribution curve, i.e., the appearance of the graph of the polymer weight fraction as function of its molecular weight.

When the molecular weight distribution curves from these fractions are superimposed into the molecular weight distribution curve for the total resulting polymer product, that curve will show two maxima or at least be distinctly broadened in comparison with the curves for the individual fractions. Such a polymer product is called bimodal. It is to be noted here that also the chemical compositions of the two fractions may be different.

Similarly the term “unimodal polymer” refers to a polymer comprising one main fraction and more specifically to the form of the polymers molecular weight distribution curve, i.e., the molecular weight distribution curve for the total polymer product shows only a single maximum.

In view of the many possible embodiments to which the principles of the present disclosure can be applied, it should be recognized that the illustrated embodiments are only examples and should not be taken as limiting the scope of the following claims. We therefore claim all that comes within the scope and spirit of these claims.

We claim:

1. A method of forming a golf ball construct, comprising:
injecting a viscous polymer into a mold defining a cavity having a core or mantle portion of a golf ball substantially centered relative to the cavity, wherein a plurality of spaced-apart radial film gates are circumferentially positioned relative to the cavity;
conveying the viscous polymer into the cavity and through the plurality of radial film gates and into a volume defined between the core or mantle portion and the mold so as to form a substantially uniformly distributed polymer layer;
allowing the polymer layer to solidify to form a solidified polymer layer, and
removing the golf ball construct from the mold cavity.

2. The method of claim 1, wherein the plurality of radial film gates comprises four radial-film gates occupying between about 45 percent and about 90 percent of a major circumference of the cavity.

3. The method of claim 2, wherein the polymer is one of thermoplastic resin, a blend of thermoplastic resin, thermoplastic elastomer, thermoplastic vulcanizate, post-curable resin, thermoset resin, and any combination of those.

4. The method of claim 2, wherein the polymer is one of an ionomer, ionomer blend, a polyamide, a thermoplastic polyurethane, a polyalkenamer composition, a post-curable resin, a thermosetting polyurethane, and any combination of those.

5. The method of claim 1, wherein the solidified polymer layer comprises a layer of the golf ball construct having a maximum thickness less than about 0.055 inch and the viscous polymer has a melt flow index less than about 10.

6. The method of claim 1, wherein the solidified polymer body has a maximum thickness between about 0.025 inch and about 0.045 inch, and wherein the viscous polymer has a melt flow index greater than or equal to 10.

7. The method of claim 1, wherein the polymer layer comprises at least one inner layer of the golf ball construct.

8. The method of claim 1, wherein the polymer layer comprises an outer most layer of the golf ball construct.

9. The method of claim 1, wherein the gates define respective openings having a uniform dimension.

10. The method of claim 1, wherein at least one of the gates defines an opening having a non-uniform dimension.

11. The method of claim 10, wherein the non-uniform dimension tapers between opposing ends of the opening.

12. The method of claim 11, wherein at least one step separates a first region having a first thickness from a second region having a second thickness.

13. An injection mold for manufacturing golf balls, comprising:
at least one substantially spherical cavity region having a major circumference and defining two corresponding opposed pole regions,
a plurality of spaced-apart radial film gate regions adjoining the cavity region and being so positioned relative to the cavity region as to define at least one line of substantial symmetry;
a plurality of core pins for retaining a golf ball core in a substantially centered position relative to the cavity region, and
at least one vent region adjacent each opposed pole region.

14. The mold of claim 13, wherein the radial film gate regions define a uniform gate thickness.

15. The mold of claim 13, wherein at least one of the radial film gate regions defines a non-uniform gate thickness.

16. The mold of claim 13, wherein the at least one of the radial film gate regions comprises first and second gate portions defining first and second gate thicknesses, respectively.

17. The mold of claim 13, further comprising a runner portion fluidicly coupled to the at least one of the radial film gate regions, wherein the first gate portion is proximately positioned relative to the runner and the second gate portion is distally positioned relative to the runner portion, and wherein the second thickness is greater than the first thickness.

18. The mold of claim 13, wherein the at least one substantially spherical cavity region comprises four substantially spherical cavity regions.

19. A golf ball comprising a layer having a maximum thickness not greater than about 0.055 inch and substantially uniformly surrounding a core, the layer formed by a method comprising:
melting a polymeric resin;
conveying the polymeric resin through a plurality of radial film gates into a cavity so as to form the layer;
cooling the layer; and
removing the ball from the cavity.

20. The golf ball of claim 19, wherein the maximum thickness is not greater than about 0.045 inch.

21. A golf ball comprising a dimpled thermoplastic polymer outer layer having a maximum thickness not greater than about 0.055 inch and substantially uniformly surrounding a core, the outer layer formed by a method comprising:
melting a post-curable thermoplastic resin;
conveying the thermoplastic resin through a plurality of radial film gates into a cavity so as to form the outer layer;
heating the outer layer; and
removing the ball from the cavity.

22. The golf ball of claim 21, wherein the maximum thickness is not greater than about 0.045 inch, and wherein the post-curable thermoplastic resin has a melt flow index greater than or equal to 10.

23. A system of at least two injection-mold inserts fluidicly coupled with a source of thermoplastic polymer, wherein the system is configured to define a substantially spherical cavity for injection molding a layer of a golf ball, wherein at least one of the inserts comprises:
a recessed cavity region defining at least a portion of the substantially spherical cavity;
a mating surface configured to matingly engage a corresponding mating surface of the at least one other injection mold insert;
a recessed runner region adjoining the mating surface and having a runner surface being recessed from the mating surface by a first distance;
a recessed radial film gate region adjoining the mating surface and defining at least one corresponding gate surface being recessed from the mating surface, the radial film gate region being positioned between and adjoining the recessed runner region and the recessed cavity region, wherein the at least one gate surface is recessed from the mating surface by a distance less than the first distance.

24. The system of claim 23, wherein the radial film gate region is recessed from the mating surface by between about 0.010 inch and 0.030 inch.

25. The system of claim 23, wherein the at least one gate surface is uniformly recessed from the mating surface.

26. The system of claim 23, wherein the at least one gate surface comprises a first gate surface, the recessed radial gate region defining a second gate surface being recessed from the mating surface.

27. The system of claim 26, wherein the first gate surface and the second gate surface are separated by a step.

28. The system of claim 27, wherein a substantially continuous taper joins the first gate surface and the second gate surface.

29. The system of claim 23, wherein the recessed gate region comprises two spaced-apart and recessed end regions and a center region extending between the end regions.

30. The system of claim 29, wherein at least one end region adjoins the mating surface and separates the center region from the mating surface.

31. The system of claim 29, wherein each end region comprises a curved surface.

32. The system of claim 23, wherein the recessed cavity region adjoins a vent aperture.

33. The system of claim 32, wherein an axis extending between poles of the substantially spherical cavity extends through the vent aperture.

34. An injection mold for forming a layer of a golf ball construct, the mold comprising:
a plurality of mold portions defining respective recessed regions being so configured as to define a substantially spherical cavity when the plurality of mold portions are operatively arranged;
a portion of a runner system configured to convey an injection material;
a plurality of radial film gate portions configured to fluidly couple the runner system and the substantially spherical cavity and convey the injection material therebetween, wherein each radial film gate portion defines a gate opening having a width-to-thickness ratio of at least 4:1.

35. The injection mold of claim 34, wherein each of the plurality of mold portions comprises a respective mold insert.

36. The injection mold of claim 35, wherein each of the respective mold inserts defines a portion of one or more of the plurality of radial film gate portions.

37. The injection mold insert of claim 34, wherein the radial film gate portions are so positioned as to occupy a substantially common plane in spaced apart relation to each other and to occupy less than about 90% of a major circumference of the substantially spherical cavity.

38. The golf ball of claim 19, wherein the layer comprises a unimodal ionomer, a bimodal ionomer, a modified unimodal ionomer, a modified bimodal ionomer, a thermoset polyurethane, a thermoplastic polyurethane, thermoset polyurea, a thermoplastic polyurea, a polyester elastomer, a polyalkenamer rubber selected from the group consisting of polybutenamer rubber, polypentenamer rubber, polyhexenamer rubber, polyheptenamer rubber, polyoctenamer rubber, polynonenamer rubber, polydecenamer rubber polyundecenamer rubber, polydodecenamer rubber, polytridecenamer rubber and any combinations thereof, a copolymer comprising at least one first co-monomer selected from butadiene, isoprene, ethylene or butylene and at least one second co-monomer selected from a (meth)acrylate or a vinyl arylene, a blend of an ionomer and a block copolymer, the block copolymer being selected from styrenic block copolymers including styrene-butadiene-styrene, styrene-ethylene-butylene-styrene and styrene-ethylene/propylene-styrene, functionalized styrenic block copolymers including functionalized styrenic block copolymers incorporating a first polymer block having an aromatic vinyl compound, a second polymer block having a conjugated diene compound and a hydroxyl group located at a block copolymer, or its hydrogenation product, and in which the ratio of block copolymer to ionomer ranges from 5:95 to 95:5 by weight or any combination thereof.

39. The golf ball of claim 38, wherein the layer comprises a composition prepared by blending together at least three materials, identified as Components A, B, and C, and melt-processing Components A, B and C to form in-situ, a polymer blend composition incorporating a pseudo-crosslinked polymer network,
wherein Component A comprises a monomer, oligomer, prepolymer or polymer that incorporates at least 5% by weight of at least one type of an acidic functional group, including ethylene/(meth)acrylic acid copolymers and ethylene/(meth)acrylic acid/alkyl (meth)acrylate terpolymers, or ethylene and/or propylene maleic anhydride copolymers and terpolymers;
wherein Component B comprises block copolymers such as styrenic block copolymers including styrene-butadiene-styrene, styrene-ethylene-butylene-styrene, and styrene-ethylene/propylene-styrene, functionalized styrenic block copolymers, including those where the block copolymer incorporates a first polymer block having an aromatic vinyl compound, a second polymer block having a conjugated diene compound and a hydroxyl group located at a block copolymer, or its hydrogenation product; and
wherein Component C comprises a base capable of neutralizing the acidic functional group of Component A and comprising metal salts, metal hydroxides, metal oxides, metal carbonates, and/or metal acetates of lithium, sodium, magnesium, aluminum, potassium, calcium, manganese, tungsten, titanium, iron, cobalt, nickel, hafnium, copper, zinc, barium, zirconium, tin.

40. The golf ball of claim 38, wherein the layer comprises a bimodal polymer blend compositions comprising:
a) a high molecular weight component having a weight average molecular weight, Mw, of about 80,000 to about 500,000 and comprising one or more ethylene/α, β-ethylenically unsaturated C₃₋₈ carboxylic acid copolymers and/or one or more ethylene, alkyl (meth)acrylate, (meth)acrylic acid terpolymers, the high molecular weight component being partially neutralized with metal ions selected from the group consisting of lithium, sodium, zinc, calcium, magnesium, and mixtures thereof; and
b) a low molecular weight component having a weight average molecular weight, Mw, of from about 2,000 to about 30,000 and comprising one or more ethylene/α, β-ethylenically unsaturated C₃₋₈ carboxylic acid copolymers and/or one or more ethylene, alkyl (meth)acrylate, (meth)acrylic acid terpolymers, said low molecular weight component being partially neutralized with metal ions selected from the group consisting of lithium, sodium, potassium, magnesium, calcium, barium, lead, tin, zinc or aluminum, and mixtures thereof.

41. The golf ball of claim 38, wherein the layer comprises a modified unimodal ionomer prepared by mixing:
a) an ionomeric polymer comprising ethylene, from 5 to 25 weight percent (meth)acrylic acid, and from 0 to 40 weight percent of a (meth)acrylate monomer, the ionomeric polymer neutralized with metal ions selected from the group consisting of lithium, sodium, potassium, magnesium, calcium, barium, lead, tin, zinc or aluminum, and mixtures thereof; and
b) from about 5 to about 40 weight percent (based on the total weight of the modified ionomeric polymer) of one or more fatty acids or metal salts of the fatty acid, the metal selected from the group consisting of lithium, sodium, potassium, magnesium, calcium, barium, lead, tin, zinc or aluminum, and mixtures thereof.

42. The golf ball of claim 38, wherein the layer comprises:
(A) from about 85 to about 99 wt % (based on the combined weight of Components A and B) of a block copolymer; and
(B) from about 1 to about 15 wt % (based on the combined weight of Components A and B) of one or more modifying agents selected from the group consisting of amino acids, aminotriazines, dicyandiamides and polyamines and any and all combinations thereof.
